(19) United States
(12) Patent Application Publication
(10) Pub. No.: US 2020/0281692 A1
(43) Pub. Date: Sep. 10, 2020

(54) ORTHODONTIC SYSTEM

(71) Applicant: ORTHOMATRIX CORP., INC, GERMANTOWN, TN (US)

(72) Inventor: Steve Alan Galella, Collierville, TN (US)

(73) Assignee: ORTHOMATRIX CORP., INC, GERMANTOWN, TN (US)

(21) Appl. No.: 16/751,308

(22) Filed: Jan. 24, 2020

Related U.S. Application Data
(63) Continuation-in-part of application No. 29/711,791, filed on Nov. 2, 2019.
Application No. 29/711,791 is a continuation-in-part of application No. 29/711,792, filed on Nov. 2, 2019.
Application No. 29/711,792 is a continuation-in-part of application No. 29/711,793, filed on Nov. 2, 2019.
(60) Provisional application No. 62/813,560, filed on Mar. 4, 2019.

(51) Int. Cl. A61C 7/30; A61C 7/28

(52) U.S. Cl. CPC A61C 7/30; A61C 7/18; A61C 7/287

(57) ABSTRACT

Embodiments of the present invention are directed to an orthodontic system and associated method that provides complete and predictable control of tooth movement. Such complete and predictable control of tooth movement affords a practitioner with a means to develop arches and to direct tooth movement. To this end, embodiments of the present invention provide an efficient and effective component system and method of use for addressing commonly encountered treatment problems. These common problems include but are not limited to maxillary labial crown torque (dumping), mandibular labial crown torque (dumping), protrusion of the upper or lower lip, incomplete coupling of the anterior teeth, case finishing and lingual dumping of mandibular molars.

### CROSS-REFERENCE TO RELATED APPLICATIONS

This non-provisional utility patent application claims priority from co-pending U.S. Provisional Patent Application having Ser. No. 62/813,560, filed 4 Mar. 2019, entitled “ORTHODONTIC SYSTEM”, having a common applicant herewith and being incorporated herein in its entirety by reference.

This non-provisional utility patent application claims, as a continuation-in-part application, priority from co-pending U.S. Design patent application having Ser. No. 29/711,791, filed 2 Nov. 2019, entitled “ORTHODONTIC APPLIANCE”, having a common applicant herewith and being incorporated herein in its entirety by reference.

This non-provisional utility patent application claims, as a continuation-in-part application, priority from co-pending U.S. Design patent application having Ser. No. 29/711,792, filed 2 Nov. 2019, entitled “ORTHODONTIC APPLIANCE”, having a common applicant herewith and being incorporated herein in its entirety by reference.

This non-provisional utility patent application claims, as a continuation-in-part application, priority from co-pending U.S. Design patent application having Ser. No. 29/711,793, filed 2 Nov. 2019, entitled “ORTHODONTIC APPLIANCE”, having a common applicant herewith and being incorporated herein in its entirety by reference.

### FIELD OF THE DISCLOSURE

The disclosures made herein relate generally to orthodontic systems and methodologies and, more particularly, to an orthodontic system and a method comprising improved system implements of the orthodontic system.

### BACKGROUND

It is well known that orthodontic treatment is a specialized type of treatment within the field of dentistry and involves movement of malpositioned teeth to/preferably toward orthodontically correct locations. Orthodontic treatment is intended to improve a patient's occlusion and typically enhances the aesthetic appearance of the teeth. To this end, orthodontic treatment are useful in correcting alignment of teeth to proper positions and orientations in the dental arch and to improve dental health.

Traditionally, orthodontic treatment involves the use of a set of appliances and wires that are commonly known collectively as “braces”. During such treatment, small appliances known as brackets are fixed to the patient's anterior, cuspid and bicuspid teeth, and an arch wire is inserted into a slot of each bracket. The arch wire forms a track to guide movement of the teeth to orthodontically correct locations. End sections of the arch wire are typically captured in tiny appliances known referred to as molar band tubes (also known as molar buccal tubes) that are fixed to the patient's molar teeth.

In some examples, orthodontic braces include metal brackets bonded to the teeth and arch wires that are tied to the brackets by elastic ties. The arch wires are designed to apply force to the brackets and teeth, causing the teeth to slowly move or rotate in prescribed directions. The arch wires are adjusted (e.g., every three or four weeks) during treatment to maintain force in order to supply prescribed forces to the teeth.

When an orthodontist intends on straightening a patient's teeth, the orthodontist must design the patient's braces. The braces are an appliance providing means to exert forces on the crooked, or nonaligned, teeth to cause the teeth to be moved and to be brought into alignment. The presently conventional orthodontic appliances are constructed, for example, by attaching a bracket to each tooth to be moved, then fixing a wire to each bracket to exert the desired forces on the tooth. The result is that a bracket is fixed with respect to a given tooth, the bracket being adapted to receive wires to bring about desired motion of the tooth via application of force.

It is well known that conventional orthodontic systems have less than desirable and predictable control of tooth movement. Therefore, an orthodontic system and method comprising improved system implements thereof that overcomes shortcomings associated with conventional orthodontic systems would be advantageous, desirable and useful.

### SUMMARY OF THE DISCLOSURE

Embodiments of the present invention are directed to an orthodontic system and associated method that provides complete and predictable control of tooth movement. Such complete and predictable control of tooth movement affords a practitioner with a means to develop arches and to direct tooth movement. To this end, embodiments of the present invention provide an efficient and effective component system and method of use for addressing commonly encountered treatment problems. These common problems include but are not limited to maxillary labial crown torque (dumping), mandibular labial crown torque (dumping), protrusion of the upper or lower lip, incomplete coupling of the anterior teeth, case finishing and lingual dumping of mandibular molars.

Orthodontic systems and associated methods in accordance with embodiments of the present invention offer several advantages relative to conventional (i.e., prior art) orthodontic systems and methods of use thereof. These advantages include, but are not limited to, ease of transition from conventional orthopedic system implements (e.g., functional appliances) to fixed appliances thereof, extended arch development capabilities, application of multiple mechanical actions, application of case finishing, and continuation of case improvement after case finishing. Thus, these advantages provide for long-term stability throughout treatment, movements of teeth and bone in a controlled manner, problem free course of treatment, and easier case finishing.

Patients treated with orthodontic systems and associated methods in accordance with embodiments of the present invention (i.e., the inventive fixed appliances and methods of use thereof) demonstrate excellent stability of the developed arches. The effect of using such inventive fixed appliances and methods of use thereof to remodel the alveolar bone in order to create a stable base of support for the dentition is beneficial for functional-orthopedic appliances. The inventive fixed appliances and methods of use thereof encourages development of the maxillary and mandibular arches to a reliable and predictable Class I occlusal relationship. To this end, the inventive fixed appliances and methods of use thereof were conceived and designed as a viable response to commonly encountered treatment problems. To this end, it provides a predictable and excellent form of treatment.

In one or more embodiments of the present invention, an orthodontic appliance comprises a molar band assembly, an active pressure wire and a stoplock. The molar band assembly includes a molar band and a pressure wire mounting structure attached to the molar band. The molar band is adapted for being mounted on a maxillary molar of a patient. The active pressure wire has a distal end portion and a proximate end portion attached to the distal end portion. The distal end portion is slidably engaged with the pressure wire mounting structure. The stoplock is repositionably secured to the active pressure wire at a location between the distal and proximate end portions thereof. The pressure wire mounting structure is forcibly coupled to the stoplock to bias the proximate end portion of the active pressure away from the molar band tube.

In one or more embodiments of the present invention, an orthodontic appliance comprises opposing molar bands, one or more force delivery structures and opposing appliance load assemblies. The opposing molar bands are each adapted for being mounted on a respective maxillary molar of a patient. The one or more force delivery structures are each adapted for being engaged with at least one of a dental palette of the patient and one or more maxillary incisors thereof. The opposing appliance load assemblies each include a stoplock, a molar band tube and an active pressure wire. The molar band tube is attached to a respective one of the molar bands. A force-receiving portion of the active pressure wire is slidably engaged with the molar band tube and a force-delivering portion of the active pressure wire is fixedly engaged with at least one of the one or more force delivery structures. The stoplock is repositionably secured to the force-receiving portion of the active pressure wire. The molar band tube is forcibly coupled to the stoplock to bias the force-delivering portion of the active pressure away from the molar band tube.

In one or more embodiments, an orthodontic appliance comprises opposing posterior orthodontic bands, opposing anterior orthodontic bands, a palatal pad and opposing appliance load assemblies. The opposing posterior orthodontic bands are each adapted for being mounted on a respective maxillary first molar of a patient. The opposing anterior orthodontic bands are each adapted for being mounted on a respective maxillary first bicuspid of the patient. Each of the anterior orthodontic bands is fixedly attached to a respective adjacent one of the posterior orthodontic bands. The palatal pad is adapted for being engaged with a dental palette of the patient. The opposing appliance load assemblies each include a stoplock, a molar band tube, an active pressure wire and an activation spring. The molar band tube is attached to a respective one of the posterior molar bands. A force-receiving portion of the active pressure wire is slidably engaged within a central passage of the molar band tube and a force-delivering portion of the active pressure wire is fixedly engaged with the palatal pad. The activation spring is positioned between the molar band tube and the stoplock. The stoplock is repositionably secured to the force-receiving portion of the active pressure wire so as to enable compression of the activation spring between the molar band tube and the stoplock whereby the force-delivering portion of the active pressure is biased away from the molar band tube.

In one or more embodiments, the one or more force delivery structures consists of a palatal pad adapted for being engaged with the dental palette of the patient and the force-delivering portion of the active pressure wire of each of the opposing appliance load assemblies is fixedly engaged with the palatal pad.

In one or more embodiments, the force-delivering portion of the active pressure wire is fixedly engaged directly with the palatal pad.

In one or more embodiments, each one of the appliance load assemblies includes a force transfer wire, the force-delivering portion of the active pressure wire is fixedly engaged directly with a first end portion of the force transfer wire and the palatal pad is fixedly engaged directly with a second end portion of the force transfer wire.

In one or more embodiments, the active pressure wire is made from a thermally reactive material that generates a displacement force as a function of temperature thereof.

In one or more embodiments, the thermally reactive material is nickel titanium wire.

In one or more embodiments, the stoplock is engaged against a forward-facing end of the pressure wire mounting structure for enabling the displacement force generated by the active pressure wire to be applied through the stoplock to the pressure wire mounting structure.

In one or more embodiments, the orthodontic appliance further comprises opposing anterior orthodontic bands each adapted for being mounted on a respective maxillary bicuspid of the patient.

In one or more embodiments, the orthodontic appliance further comprises pressure wire eyelets each attached to a respective one of the anterior orthodontic bands.

In one or more embodiments, the active pressure wire of each of the appliance load assemblies extends through an associated one of the pressure wire eyelets.

In one or more embodiments, the orthodontic appliance further comprises helical-wound activation springs each positioned between the pressure wire mounting structure and the stoplock of a respective one of the appliance load assemblies.

In one or more embodiments, the distal end portion of the active pressure wire extends through a central passage of the activation spring and the stoplock is repositionably secured to the active pressure wire so as to enable compression of the activation spring between the pressure wire mounting structure and the stoplock whereby the force-delivering portion of the active pressure is biased away from the pressure wire mounting structure.

In one or more embodiments, the molar band tube has a central passage and the distal end portion is slidably engaged within the central passage of the molar band tube.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a plan view showing an orthodontic system configured in accordance with the present invention.

FIG. 2 is a plan view showing forces applicable to a fixed removable lingual arch of the orthodontic system shown in FIG. 1.

FIG. 3 is a side view showing forces applicable to a fixed removable lingual arch of the orthodontic system shown in FIG. 1.

FIG. 4 is a side view showing the fixed removable lingual arch of the orthodontic system of FIG. 1 attached to a lingual sheath thereof.

FIG. 5 is a side view showing attachment of the fixed removable lingual arch of the orthodontic system of FIG. 1 detached from the lingual sheath thereof.

FIG. 6 is a cross-sectional view showing the fixed removable lingual arch of the orthodontic system of FIG. 1 attached to the lingual sheath thereof.

FIG. 7 is a side view showing a molar band tube, stoplock, anterior arch wire of the orthodontic system shown in FIG. 1.

FIG. 8 is a cross-sectional view taken along the line 8-8 in FIG. 7.

FIG. 9 is a cross-sectional view taken along the line 9-9 in FIG. 7.

FIG. 10A is a side view of a first alternate embodiment of a stoplock in accordance with the present invention, wherein the stoplock includes a stoplock body with the fastener provided in a side face of the stoplock body for securing an anterior arch wire extending through the stoplock body.

FIG. 10B is a cross-sectional view taken along the line 10B-10B in FIG. 10A.

FIG. 10C is a side assembly view showing a second alternate embodiment of a stoplock in accordance with the present invention.

FIG. 10D is a first side view showing a stoplock body of the stoplock shown in FIG. 10C.

FIG. 10E is a second side view showing the stoplock body of the stoplock shown in FIG. 10C.

FIG. 10F is a top face view of the stoplock body of the stoplock shown in FIG. 10C, wherein a retention member of the stoplock is shown in relation thereto.

FIG. 11A is bite-side perspective view showing a premade occlusal pad configured in accordance with the present invention.

FIG. 11B is bonding-side perspective view showing a premade occlusal pad configured in accordance with the present invention.

FIG. 12 is a side view showing utilization of the occlusal pad of FIG. 11.

FIG. 13 is a front perspective view showing a first embodiment of a functional orthodontic appliance in accordance with the present invention.

FIG. 14 is bottom view of the functional orthodontic appliance shown in FIG. 13.

FIG. 15 is a rear elevation view of the functional orthodontic appliance shown in FIG. 13.

FIG. 16 is a left-side elevation view of the functional orthodontic appliance shown in FIG. 13.

FIG. 17 is a front perspective view showing a second embodiment of a functional orthodontic appliance in accordance with the present invention.

FIG. 18 is bottom view of the functional orthodontic appliance shown in FIG. 17.

FIG. 19 is a rear elevation view of the functional orthodontic appliance shown in FIG. 17.

FIG. 20 is a left-side elevation view of the functional orthodontic appliance shown in FIG. 17.

FIG. 21 is a front perspective view showing a third embodiment of a functional orthodontic appliance in accordance with the present invention.

FIG. 22 is bottom view of the functional orthodontic appliance shown in FIG. 21.

FIG. 23 is a rear elevation view of the functional orthodontic appliance shown in FIG. 21.

FIG. 24 is a left-side elevation view of the functional orthodontic appliance shown in FIG. 21.

### DETAILED DESCRIPTION

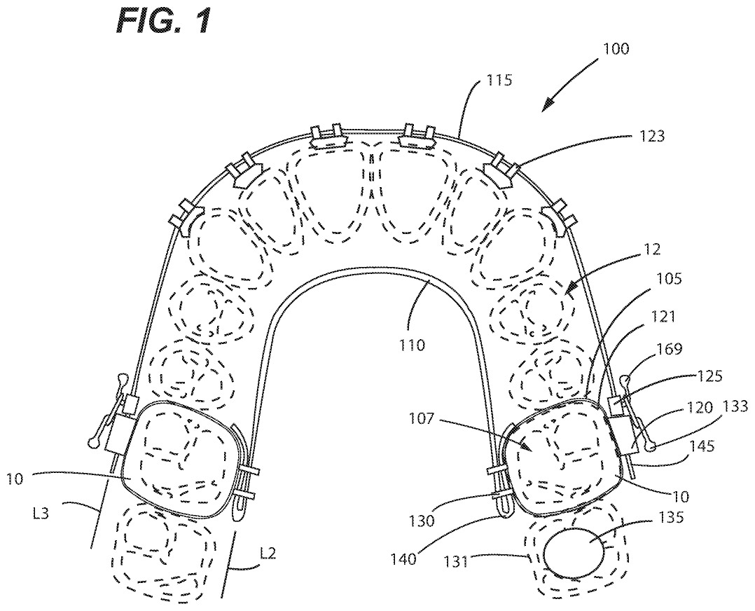

FIGS. 1-12 illustrate various aspects of components of an orthodontic system 100 in accordance with one or more embodiments of the present invention. Individually and in combination, the components of the orthodontic system 100 are fixed appliances. The orthodontic system 100, in combination with orthodontic methodologies performed therewith, provides complete and predictable control of tooth movement in a more efficient manner than prior art orthodontic systems and methods of use therefrom. In this regard, the orthodontic system 100 affords orthodontists with an improved means to develop arches and to direct tooth movement. Moreover, the orthodontic system 100 provides an efficient and effective component system and methods of use thereof for addressing commonly encountered treatment problems such as, for example: maxillary labial crown torque (dumping), mandibular labial crown torque (dumping), protrusion of the upper or lower lip, incomplete coupling of the anterior teeth, case finishing and lingual dumping of mandibular molars.

Referring now to FIG. 1, the orthodontic system 100 includes molar bands 105, a fixed removable lingual arch (FRLA) 110, an anterior arch wire 115, molar band tubes 120, arch wire pads 123, stoplocks 125, lingual sheaths 130 and occlusal pads 135. The molar bands 105 are mounted on teeth 10 (e.g., mandibular molars) of an upper or lower arch 12 at a rear portion of a patient's mouth. For example, tooth 10 is positioned within a tooth receiving space 107 of a respective one of the molar bands 105. The tooth receiving space 107 has a longitudinal axis L1. Each of the molar bands 105 has one of the molar band tubes 120 fixedly attached thereto at an anterior side 121 thereof and has one of the lingual sheaths 130 fixedly attached thereto at a lingual side 131 thereof. The molar band tube 120 and the lingual sheath 130 are spaced apart from each other around the tooth receiving space 107 of the respective one of the molar bands 105 by 180 degrees or about 180 degrees. A molar band hook 133 (i.e., molar hook) can be fixedly attached to a top, side or bottom face of each of the molar band tubes 120. In some embodiment, the occlusal pads 135 can be mounted on a biting surface of one or more of the molars of the upper or lower arch 12. In one or more embodiments, the FRLA 110 can be in a premade form in the shape of the inside of the upper or lower arch from round stainless-steel wire having a diameter of 0.036″. Optionally, the FRLA 110 is made from temperature sensitive arch wire. The FRLA 110 can be provided in a plurality of sizes to accommodate different size arches.

Opposing end portions 140 of the FRLA 110 are each engaged with a respective one of the with the lingual sheaths 130 for enabling force to be transmitted between each of the opposing end portions 140 of the FRLA 110 and a respective one of the lingual sheaths 130. Opposing ends 145 of the anterior arch wire 115 are each positioned within a passage 160 of a respective one of the molar band tubes 120 with the anterior arch wire 115 extending therethrough and fixedly retained therein in slidable relation thereto. Each one of the stoplocks 125 is engaged with a forward-facing end of a respective one of the molar band tubes 120 for enabling force to be transmitted between each of the stoplocks 125 and the respective one of the molar band tubes 120. The FRLA 110 is placed to rest gently on the intraoral tissue, without touching any teeth other than the molars to which is attached.

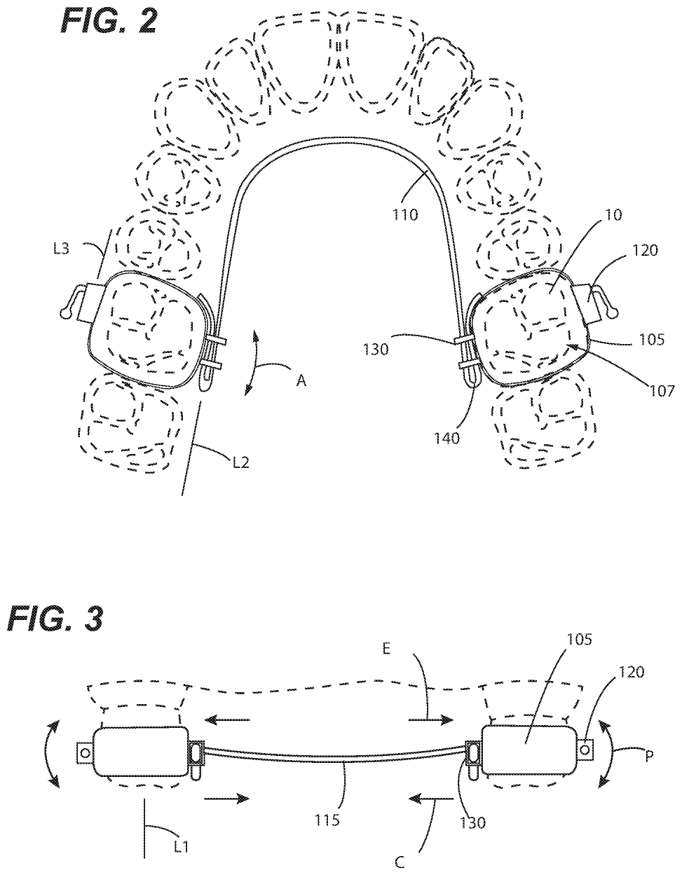

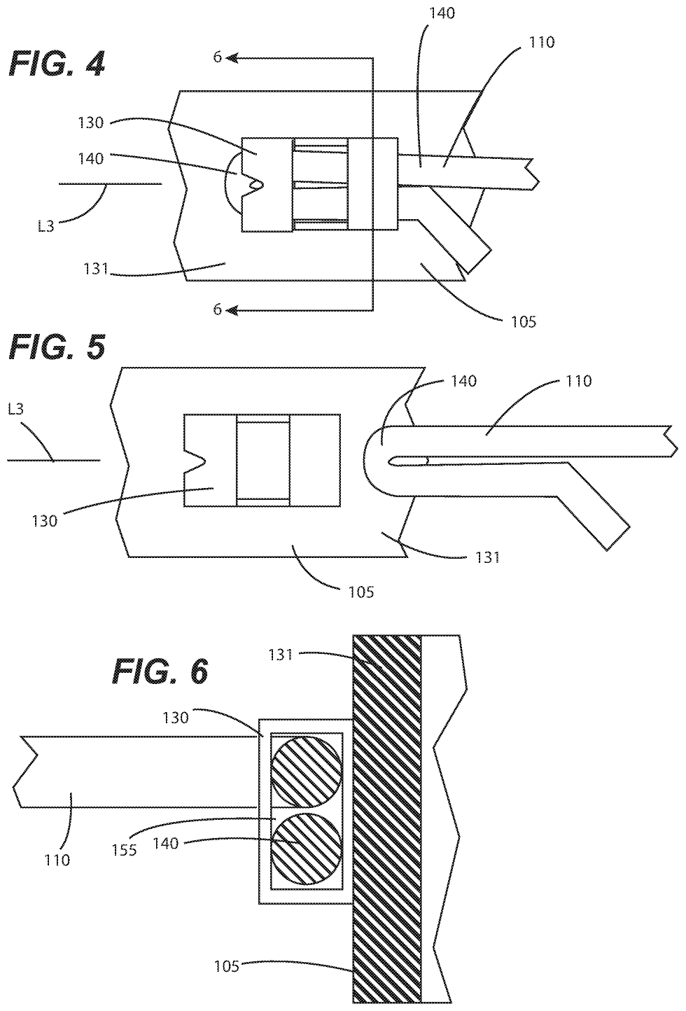

As best shown in FIGS. 2 and 3, coupling of the FRLA 110 to the lingual sheaths 130 exerts force on the teeth 12 to which the lingual sheaths 130 are mounted for achieving expansion movement E, constriction movement C, axial rotation movement A, and/or planar rotation P of such teeth. To this end, each of the molar bands 105 can be fixedly secure to the teeth via a suitable adhesive, cement, epoxy or the like. The opposing end portions 140 of the FRLA 110 and the lingual sheaths 130 can be jointly configured to inhibit or substantially limit axial, transverse, longitudinal and rotational movement therebetween, thereby enabling force generated by the FRLA 110 to be transmitted between each of the opposing end portions 140 of the FRLA 110 and a respective one of the lingual sheaths 130. For example, as shown in FIGS. 4-6, the opposing end portions 140 of the FRLA 110 and the lingual sheaths 130 can be jointly shaped to inhibit unrestricted axial and transverse rotation of the opposing end portions 140 of the FRLA 110 with respect to the lingual sheaths 130. In one embodiment, wire from which the FRLA 110 is made can be doubled over to form the opposing end portions 140 and the lingual sheaths 130 can include a lingual sheath passage 155 correspondingly shaped (e.g., rectangular cross-section) to receive these opposing end portions 140 in a manner that holds the FRLA 110 in a constrained relative position. Although the FRLA 110 is shown with a round cross-section, it is disclosed herein that the FRLA 110 can be configured with other cross-sectional shapes (e.g., rectangular). A longitudinal axis L2 of the lingual sheath passage 155 extends perpendicular or about perpendicular to the longitudinal axis L1 of the tooth receiving space 107.

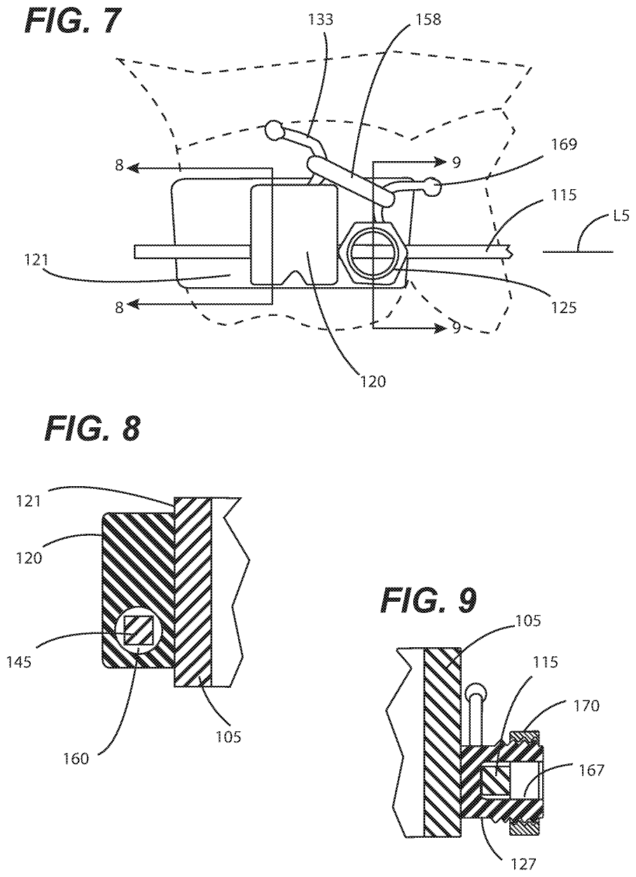

FIG. 7 shows coupling of one of the opposing end portions 145 of the anterior arch wire 115 to a respective one of the molar band tubes 120 through one of the stoplocks 125. Each of the opposing end portions of the anterior arch wire 115 has one of the stoplocks 125 fixedly secured thereto. Each of the stoplocks 125 is fixedly secured to a respective one of the molar band tubes 120 via a coupling member 158 for exerting force on the respective one of the molar band tubes 120. In this respect, associated ones of the of the molar band tubes 120 and the stoplocks 125 and respective portion of the anterior arch wire 115 jointly define an appliance load assembly. Each appliance load assembly is coupled between a respective one of the molar bands 105 and one or more of the arch wire pads 123 (i.e., force delivery structures bonded to a respective tooth). Load generated by each appliance load assembly is exerted on the respective one of the molar bands 105 and the one or more of the arch wire pads 123, thereby providing force required for causing remodeling of the patient's bone structure and/or teeth placement.

As best shown in FIG. 8, each one of the opposing end portions 145 of the anterior arch wire 115 extends through a passage 160 of a stoplock body 127 of the respective one of the lock stops 125. In preferred embodiments, the portion of the anterior arch wire 115 within the passage 160 of the molar band tube 120 is slidably engaged therein. In this respect, each of the molar band tubes 120 is a pressure wire mounting structure on which the anterior arch wire 115 is slidably mounted. As best shown in FIG. 9, each one of the opposing end portions 145 of the anterior arch wire 115 extends through a stoplock channel 167 (i.e., a passage) of the respective one of the stoplocks bodies 127. An exterior surface of each of the stoplock bodies 127 has a nut 170 (i.e., a retention element) threadedly engaged with an exterior surface of a respective one of the stoplock bodies 127 such that the nut compressively engages the portion of the arch wire extending through the stoplock channel 167 for retaining each of the opposing end portions 145 of the anterior arch wire 115 in a fixed position relative to the respective one of the stoplocks 125 (i.e., inhibiting relative movement of an opposing end portion of the arch wire relative to the respective one of the stoplocks 125). Although the anterior arch wire 115 is shown with a round cross-section, it is disclosed herein that the anterior arch wire 115 can be configured with other cross-sectional shapes (e.g., rectangular). When installed, a longitudinal axis L3 of the stoplock channel 167 extends perpendicular or about perpendicular to the longitudinal axis L1 of the tooth receiving space 107. In one or more embodiments, the longitudinal axis L2 of the lingual sheath 120 and the longitudinal axis L3 of the stoplock channel 167 extend substantially or approximately parallel to each other. A molar stoplock hook 169 can be fixedly attached to a top, side or bottom face of each of the stoplocks 125.

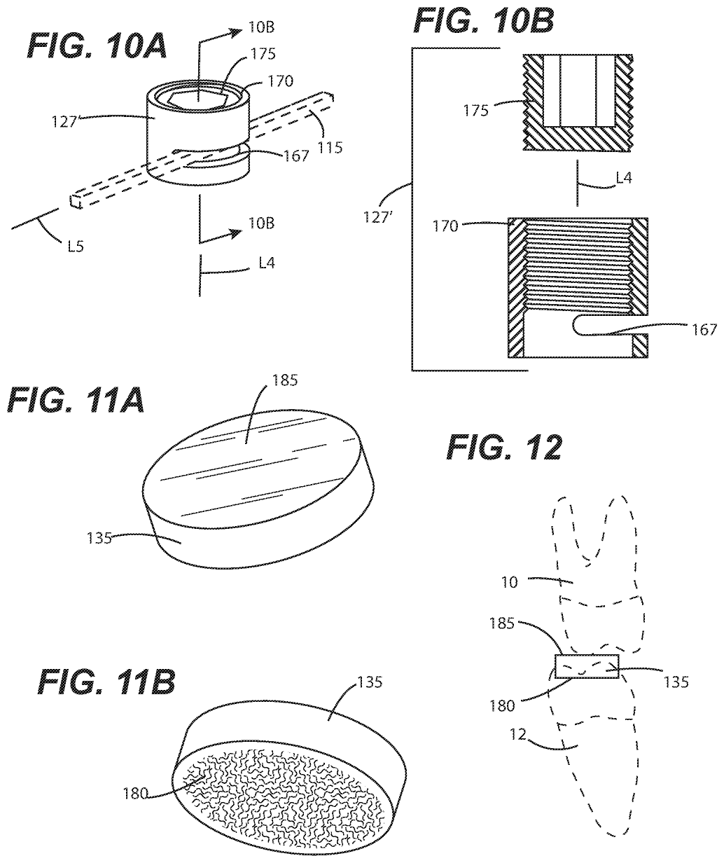

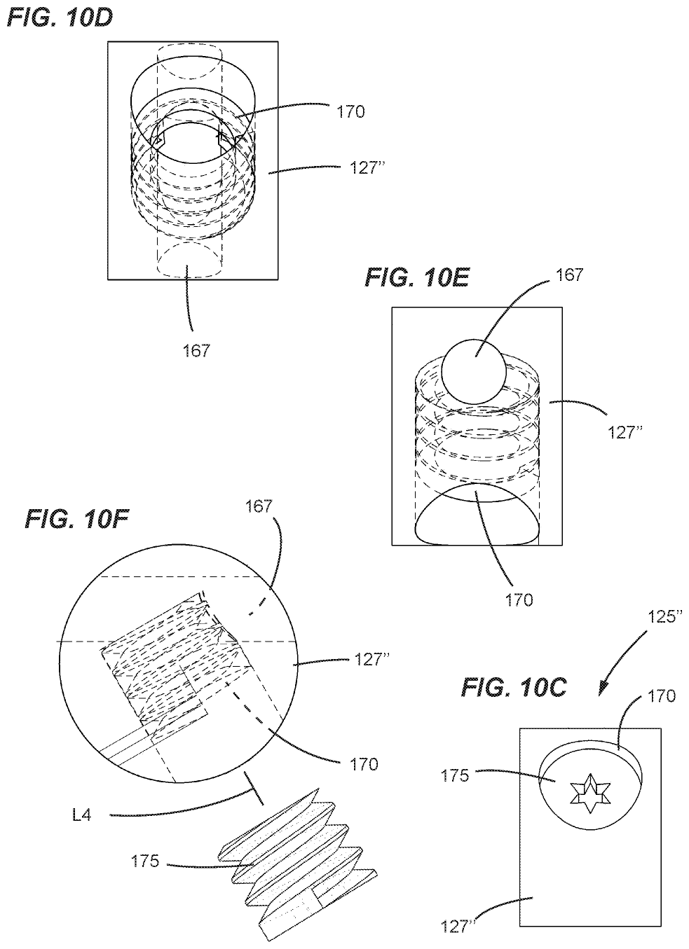

In a first alternate embodiment of a stoplock, as shown in FIGS. 10A and 10B, the stoplocks 125′ include a stoplock body 127′ having a retention member receptacle 170 therein that intersects the stoplock channel 167 through which one of the end portions of the anterior arch wire 115 (or other wire or appliance structure) extends. A retention member 175 (e.g., a setscrew) is threadedly engaged within the retention member receptacle 170 for enabling compressive engagement between the retention member 175 and the portion of the anterior arch wire 115 within the stoplock channel 167. The retention member receptacle 170 is located in a side face of the stoplock body 127′. Engagement of the retention member 175 against the portion of the anterior arch wire 115 within stoplock channel 167 inhibits unrestricted movement of the portion of the anterior arch wire 115 within the stoplock channel 167. As shown, a longitudinal axis L4 of the retention member receptacle 170 is substantially or approximately perpendicular to a longitudinal axis of the stoplock channel 167. In one or more other embodiments, the longitudinal axis L4 of the retention member receptacle 170 is skewed with respect to a longitudinal axis of the stoplock channel 167, thereby allowing access to the retention member 175 from the front of an open mouth. In another alternate embodiment (not shown), a stoplock body 127″ (generally and similarly configured as molar band tube 120′) has the retention member receptacle 175 located in a top or bottom face of the stoplock body 127″. Where the backstop body 127″ is symmetric, the top and bottom face are without difference.

In a second alternate embodiment of a stoplock, as shown in FIGS. 10C-10F, the stoplock 125″ (shown in FIG. 10C) include a stoplock body 127″ and a retention member 175 (e.g., a setscrew). The stoplock body 127″ has a retention member receptacle 170 therein that intersects the stoplock channel 167 (shown in FIGS. 10D-10F) through which one of the end portions of the anterior arch wire 115 (or other wire or appliance structure) extends. The retention member 175 is threadedly engaged within the retention member receptacle 170 for enabling compressive engagement between the retention member 175 and the portion of the anterior arch wire 115 within the stoplock channel 167. The retention member receptacle 170 is located in a side face of the stoplock body 127″. Engagement of the retention member 175 against the portion of the anterior arch wire 115 within stoplock channel 167 inhibits unrestricted movement of the portion of the anterior arch wire 115 within the stoplock channel 167′. Preferably, a longitudinal axis L4 (shown in FIG. 10F) of the retention member receptacle 170 is skewed (e.g., at about 30-degrees, as shown in FIG. 10F) with respect to the longitudinal axis of the stoplock channel 167. Such skewed arrangement can assist in enabling access to the retention member 175 from the front of an open mouth and can provide angled engagement of the retention member 175 and the element (e.g., a wire) extending through or within the stoplock channel 167. In one or more other embodiments, the longitudinal axis L4 of the retention member receptacle 170 is substantially or approximately perpendicular to the longitudinal axis of the stoplock channel 167.

In some embodiments, the anterior arch wire 115 is made from a thermally reactive material that causes force generated by the anterior arch wire 115 to be at least partially dependent upon temperature (i.e., active pressure wire), such force being suitable for causing movement of a tooth secured thereto (e.g., a length and/or stiffness of the wire is dependent upon its temperature). To this end, in one or more embodiments, the anterior arch wire 115 can be made from nickel titanium wire whose forces are controlled by variable a function of temperature (i.e. an active pressure wire). The anterior arch wire 115 being formed from such nickel titanium wire delivers dental force to move teeth in conjunction with lock steps because wires cannot slide relative to the stoplocks 125 or arch wire pads 123.

Referring now to FIGS. 11 and 12, various aspects of the occlusal pads 135 are shown. Each occlusal pad 135 has a mounting surface side 180 and a tooth bearing side 185. The mounting surface side 180 is configured for being bonded to a tooth. To provide for such bonding, all or a portion of the mounting surface side 180 can be textured, have indentions and/or be otherwise configured to enhance such bonding. Preferably, the tooth bearing side 185 is flat and smooth to allow one or more of the cusp tips 15 of an engaging tooth 12 to slide freely when biting and chewing.

The occlusal pad 135 can be supplied in 4 sizes: small, medium, large and extra-large. The thickness of the occlusal pad 135 can be about 2 mm or about 4 mm, thereby conforming to the various sizes of the occlusal surface (top) of molars on the lower arch. In preferred embodiments, the occlusal pad 135 has a square-ovoid shape to mimic the tops of molar teeth or can be a different shape such as round. Once bonded, the occlusal pads 135 can be adjusted (e.g., thickness thereof and/or angle between the mounting surface side 180 and the tooth bearing side 185), such as using a dental drill or grinder, so that the upper molar “plunger” cusps strike evenly on all the occlusal pads. In preferred implementations, the occlusal pads are level and all molars touch the opposing occlusal pad equally. The occlusal pads 135 are premade such as, for example, by 3-D printing, machining, casting, molding and/or the like.

The FRLA 110 offer a plurality of beneficial functionalities. These functionalities include:

a. Providing effective anchorage of the upper and/or lower molars to provide a reliable support for channeling force into and from the molars, thereby providing for allow predictable movement of the upper and/or lower teeth.

b. Allowing an orthodontist to expand the molars transversely (in width), contract the molars transversely (in width), rotate the molars, correct a “cant” (vertical correction), and upright slanted molars (tipped).

Placement of the FRLA 110 causes it to adjust to conform to the ideal widths of the upper and lower molars. The physical attributes of the FRLA 110 (e.g., material and shape), the translation constraining configuration of the opposing end portions 140 of the FRLA 110 and the mating configuration of the lingual sheaths 130 result force to expand, contact, upright, correct the vertical, and/or rotate the molars.

The stoplocks 125 offer a plurality of beneficial functionalities. These functionalities include:

a. The stoplocks 125 prevent the anterior arch wire 115 from sliding through the molar band tubes 120 to create a spring effect or a closed arch system. With the stoplocks 125 in place, the anterior arch wire 115 is deflected as it is place into bracket slot of each of the arch wire pads 123. When the anterior arch wire 115 is activated by the temperature in the patient's mouth, the arch wire 115 begins to generate force sufficient for returning to its original shape (i.e., as made shape) moving the teeth bodily (root and crown together) into the broad arch position. In this respect, the arch wire 115 includes a force-receiving portion to which an associated one of the stoplocks 125 is attached and a force-delivering portion to the an associated one or more of the arch wire pads 123 is attached.

b. The stoplocks 125 provide anchorage and create the spring effect of the anterior arch wire 115 to move it back to its static/unloaded shape (i.e., as made shape), thereby providing for predictable tooth movement.

c. The stoplocks 125 cause crowns and roots move together and the forces within the anterior arch wire 115 that cause the teeth to move are directed back to the stoplocks 125 and associated molars. In preferred embodiments and system component implementations, the force is the same for each bracket on each tooth. Because the stoplocks 125 cause the teeth move bodily (root and crown together), the position of the teeth are stable and there is less incidence of root resorption or damage. In contrast, prior systems and techniques rely upon the crown being moved first and, later, the roots being moved, which is difficult to manage and may cause damage to the roots by, for example, resorption.

d. The stoplocks 125 provide additional anchorage for tooth movement as well as creating a spring out of the anterior arch wire 115 (i.e., static/unloaded shape) for provides enhanced force for causing more rapid movement of the teeth.

The occlusal pads 135 offer a plurality of beneficial functionalities. These functionalities include:

a. The occlusal pads 135 provide a separation of the posterior teeth to allow independent development of the upper and lower arches (e.g., tooth movement).

The occlusal pads 135 provide protection of the temporomandibular joints (e.g., temporomandibular joints (“TMJ”) acting as a TMJ splint) and allow the movement of the lower jaw to find its ideal functional position for the patient.

b. The occlusal pads 135 having a flat occlusal surface that protects the brackets on the lower teeth from being dislodged by the upper cusp tips when a deep bite is present

c. The occlusal pads 135 are used when adjusted properly to stimulate the remodeling (shape change) of the lower jaw to a natural shape. When the lower jaw has grown vertically the patient has a long face. The occlusal pads stimulate the lower jaw to change its shape to balance the face.

d. The occlusal pads 135 are configured such that only the “plunger” cusps of the upper molars are allowed to strike the flat surface of the occlusal pads, which signals a new proprioception signal within the periodontal ligaments that the bite is normal.

Orthodontic systems in accordance with one or more embodiments of the present invention (e.g., orthodontic system 100) utilize all or apportion of the above-mentioned system components and resulting functionalities to establish a pure “straight wire” system. Such a straight wire system requires no case-by-case bending of either the FRLA or the anterior arch wire (i.e., a pure straight wire system). Without the usual complications found in other systems, treatment time with orthodontic systems and methods of use thereof configured in accordance with embodiments of the present invention is reduced dramatically (e.g., by as much as 50% less time). The bodily movement of the teeth (i.e. crown and root) provided for by such systems and method results in more stability and eliminates damage to the roots. The forces of tooth movement are controlled, predictable and repeatable.

Presented now are underlying advantages and benefits of orthodontic systems and methods thereof configured in accordance with embodiments of the present invention (i.e., the inventive fixed appliances).

### Ease of Transition from Functional Appliances to Fixed Appliances

Orthopedics as it relates to orthodontic systems and method thereof refers to the use of prior art “functional” appliance which expands or develops bone of the maxillary arch (upper arch) or mandibular arch (lower arch) by changing the shape of the supporting bone and/or tooth alignment to make room to un-crowd the teeth and correct the malocclusion. They are called functional appliances because they traditionally use the normal functions of the chewing cycles and bite positions to create these changes. Both fixed and removable functional appliances can be used to correct a malocclusion in three planes: anterior-posterior, vertical and transverse. Appliances used in transverse dimension are utilized to expand either the maxillary or the mandibular arch. Appliances used in the vertical dimension are used to correct open or deep bite.

When the functional appliances are used, the transition to braces (i.e., fixed appliances) is often complex when using prior art systems and method thereof because of the interference of the upper and lower teeth when they bite together or chewing occurs. In contrast, orthodontic systems and methods thereof configured in accordance with embodiments of the present invention (i.e., fixed appliances) maintain and stabilize the changes made by functional appliances. Such orthodontic systems and methods can use occlusal pads to protect the TMJs (temporomandibular joints) and allow the mandible to find its ideal functional position without allowing the posterior (back) teeth to come together. The space opened is slight, however this allows the freedom of movement of the lower jaw without impinging of the upper jaw. With the teeth separated by the occlusal pads, the development of the upper arch and lower arch with braces becomes two independent processes independent of one another. The occlusal pads preclude the intercuspation (interdigitation) of the teeth applying forces, thereby inhibiting orthopedic treatment.

Advantageously, orthodontic systems and methods thereof configured in accordance with embodiments of the present invention provide for quicker case finishing with early transition from functional appliance to fixed appliances. The early transition from functional appliances to the fixed appliances is at least partially due to there being no waiting period to allow the functional appliance to become stable prior to implementing fixed appliance because the inventive fixed appliances are congruent with the biology of growth and allows stabilization to occur even when the transition is completed early. Moreover, the inventive fixed appliances quickly fine tune the results from functional appliance therapy. Because the inventive fixed appliances function in concert with the biology of facial growth, the changes induced by functional appliances are quickly “tweaked” or idealized by the forces generated by the inventive fixed appliances. Additionally, the inventive fixed appliances establish the best possible aesthetic outcome because the combination of functional appliances and the inventive fixed appliances both work towards a biological balance of the facial features and function.

### Extended Arch Development Capabilities

The inventive fixed appliances provide for predictable arch development. With the use of the anterior arch wire (e.g., an initial size with possible subsequent larger or smaller sizes) in combination with the stoplocks positioned against the molar band tubes, a practitioner can predictably shape the upper and lower arches to a desired shape. The most desirable shape is a broad arch creating a wide smile with straight teeth. Prior art orthodontic systems are limited in their ability to do this because they first require shaping the arches independently using a series of sequential wires to create an arch shape and arch shape development is limited because there is no FRLA.

The inventive fixed appliances provide for easy correction of crossbites. With the use of upper and/or lower FRLAs, crossbites located on the back teeth are easily corrected. Because the anterior arch wire and stoplocks are in place, the rest of the teeth will move with the influence of the FRLA to eliminate crossbites all around the arch. To simplify, the FRLA is used to correct the molar position and the rest of the teeth follow to their correct position. In contrast, with prior art systems, the crossbite must be corrected before the fixed appliances are installed.

The inventive fixed appliances provide for vertical arch development. Through use of overlay wires and shaping of the FRLAs, vertical corrections are completed easily. Deep bite cases (i.e., the upper front teeth cover the lower front teeth) and open bite cases (i.e., the upper front teeth are apart from the lower front teeth) are also completed in a shortened period of time. Advantageously, the corrections are self-limiting to end with the ideal relationship, which occurs because the stainless steel anterior arch wire once returned to its static as-formed shape will not allow the overlay wires to over-correct (i.e., the size and shape of the overlay wires generate insufficient force to bend the anterior arch wire.) Moreover, because the wires of the inventive fixed appliances are pure straight wires (i.e., no case-by-case, tooth-by-tooth practitioner-formed bends due in part to use of stoplocks and temperature sensitive arch wires), once the anterior arch wires return to their as-formed shape, the teeth are properly aligned and in ideal occlusion. In contrast, prior art other orthodontic systems do not allow this to happen. The vertical discrepancies must be corrected independently by bending wires for each individual tooth or using rubber bands to move segments.

The inventive fixed appliances provide easy correction of asymmetrical arches. The combination of the FRLA plus the anterior arch wire, stoplocks and molar band tubes will make the arch symmetrical because the anterior arch wire and stoplocks acts like a symmetrical spring (i.e., via stoplocks and temperature-sensitive arch wires creating a spring force and by FRLA being attached to the back carrying the stoplocks/molar band tubes) to bring the bracketed teeth into a symmetrical alignment. In contrast, prior art orthodontic systems do not allow this to happen because the asymmetries must be independently corrected with wire bending for each bracket (i.e., not pure straight wires) to move each tooth.

The inventive fixed appliances provide easy correction of canted occlusal planes. Asymmetry of the face includes upper and/or lower occlusal plane to be canted. For example, the upper occlusal plane or the incisal edges of the teeth is slant up on the patient's right side and down on the patient's left side), which appears as a crooked smile with straight teeth. Using the above example, the FRLA can be bent lower on the patient's right side and can be bent higher on the patient's left side. When the FRLA is placed with the anterior arch wire and stoplocks, the “cant” will efficiently and timely correct as a function of severity of the cant. Once the cant is corrected, the FRLA is bent back to its normal symmetrical shape and reinserted into the mouth. The FRLA corrects the molar positions vertically and the anterior arch wire and stoplocks corrects the remaining teeth at the same time as they are all connected. In contrast, prior art orthodontic systems do not allow this to happen because the cant must be independently corrected by bending wires for each individual tooth (i.e., non-straight wire).

### Application of Multiple Mechanical Actions

Because of the profound anchorage provided by the FRLAs and the stoplocks, multiple mechanics may be applied at the same time through use of the inventive fixed appliances. Examples of such mechanics include: (1) Retracting teeth in the lower arch while developing the lower shape of the arch. (2) Protracting the upper anterior teeth while rotating an upper anterior tooth at the same time. (3) Bring in or tractioning an impacted tooth into the upper arch while changing the position of other teeth. (4) Reversing interposed teeth while continuing to develop the upper arch and rotate other teeth. In contrast, prior art orthodontic systems do not allow this to happen because each mechanical movement of a tooth must be done independently since there is inadequate anchorage (e.g., to the molars) to allow for multiple and sufficiently adequate forces to be applied.

### Application of Case Finishing

Using the inventive fixed appliances, cases that involve Temporomandibular Dysfunction can be completed because of the predictable movement of the teeth without retracting the mandible and the stabilization of the mandible to protect the Temporomandibular Joints (TMJs). Similarly, complications seen with prior art techniques are eliminated with the inventive fixed appliances because it is a pure straight wire system without wire bending mechanics in the main archwire. In contrast, complications with prior art techniques occur when the arch wires are bent to move teeth (i.e., non-straight wire) due in part to resulting forces between adjacent and distal teeth (i.e., for every action, there is an equal and opposite reaction.) Furthermore, with the inventive fixed appliances, there is no wire bending and possible causes of complications are corrected early in treatment.

### Continuation of Case Improvement After Case Finishing

The inventive fixed appliances create a balanced stomatognathic system (no malocclusion and healthy TMJs) as the body continues to balance itself after the braces are removed. The results continue to improve as the body stabilizes without the constraints of the prior art fixed appliances.

### Inventive Functional Appliances

In one or more embodiments, orthodontic systems in accordance with the present invention and method of use thereof can include functional appliances that are used in conjunction with fixed appliances of such orthodontic system. Whereas the fixed appliances are configured for facilitating movement of a patient's teeth, the functional appliances are configured for facilitating development of a patient's orthodontic bone growth. Advantageously, use of both the functional and fixed appliances provides for beneficial orthodontic functionality of first remodeling a patient's jawbone structure via use of one or more functional appliances and then repositioning the patient's teeth via use of required fixed appliances.

A functional appliance in accordance with one or more embodiments of the present invention provide for bone modeling in response to mechanical forces exerted on engaged jawbone by such functional appliance. This phenomenon described by Wolff s Law, which is that mechanically induced formation and adaptation of bone tissue is mediated by bone cells that sense and respond to local mechanical cues. More simply put, bone density changes in response to changes in the functional forces on the bone. For example, in mature bone where the general form is established, the bone elements place or displace themselves, and decrease or increase their mass, in response to the mechanical demands imposed on them. Wolff's Law is supported by the observation that bones exhibit atrophy when they are not mechanically stressed and exhibit hypertrophy when they are stressed.

Orthodontic treatment using functional appliances in accordance with one of more embodiments of the present invention provide a variety of factors contribute greatly to the successful outcome for a patient. To this end, based on the current understanding of assessment factors including craniofacial biology considerations, it is preferred that clinical treatment should progress in the direction of normal facial balance (e.g., including nasomaxillary complex, mandibular position, symmetry), stable class I cuspid occlusion and stable temporomandibular joints. Indicators of progression of such clinical treatment include, but are not limited to, lip seal (e.g., competent lips and strong orbicularis oris), nasal breathing (healthy airway), absence of tongue habits), which are known in the orthodontic profession as the “BIG 3”. It should be noted that the “BIG 3” can represent more than just these three indicators of progression of such clinical treatment indicated above. When achieving the “BIG 3”, a primary objective is to equalize the complex forces relating to craniofacial biology considerations, including such factors as harmonious balance of extrinsic soft tissue influence, balanced growth, congruent function, and biological stability.

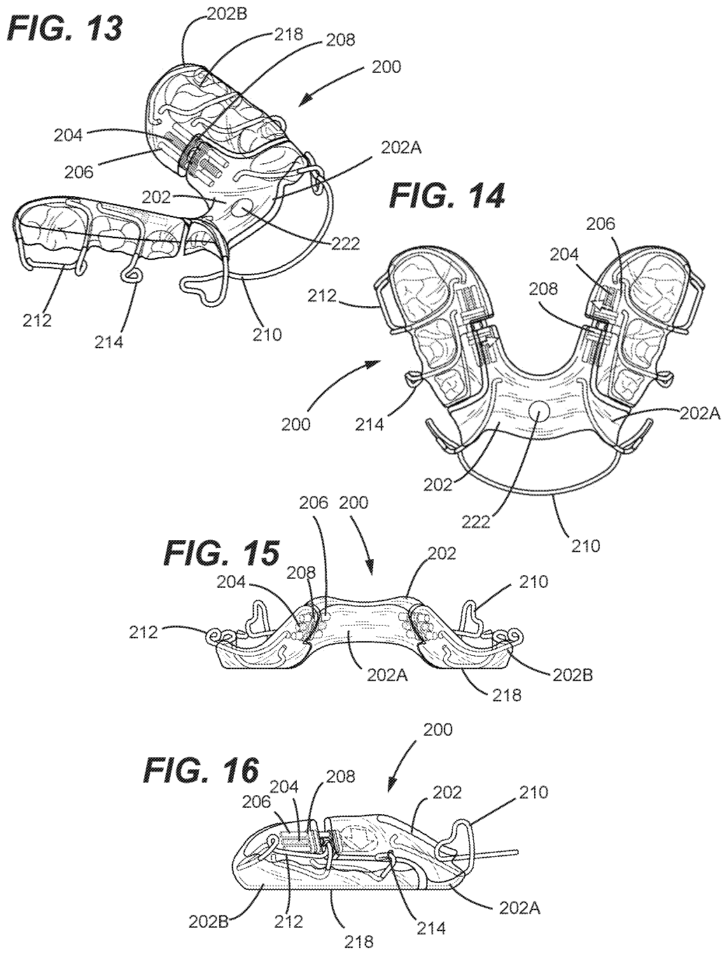

Referring now to FIGS. 13-16, a first embodiment of a functional appliance in accordance with an embodiment of the present invention (i.e., the functional appliance 200) is shown. The functional appliance 200 is a patient removable functional appliance used during a patient's orthodontic-related bone growth, thereby taking advantage of the displacement and remodeling occurring in the facial region. Advantageously, in association with the “BIG 3”, the functional appliance 200 effectively and efficiently eliminates excessive cants, eliminates excessive gingival show, and remodels the naso-maxillary complex to a more functional configuration. To this end, the functional appliance 200 stimulates the MN ramus to upright through remodeling and decreases the lower face height when the patient is in compliance with the “BIG 3” and creates a positive effect on the nasopharyngeal airway.

Because the functional appliance 200 is preferably used during bone growth stages, it takes advantage of the displacement and remodeling occurring in the facial region. For example, the functional appliance 200 is a removable functional appliance (i.e., a removable anterior growth guidance appliance) adapted for use preferably during bone growth at cervical vertebral maturation stages 3-4 (e.g., patients about 6 years old to about 10 years old with 1^{st} adult molars and 1^{st} and 2^{nd} deciduous molars) to provide 3-dimensional development of the nasal maxillary (MX) complex (also referred to as the naso-maxillary complex) and upright the mandibular (MN) ramus through remodeling. Such nasal maxillary (MX) complex (also referred to as the naso-maxillary complex) and upright the mandibular (MN) ramus are jointly referred to herein as orthodontic-related bone growth. Cervical vertebral maturation stages are known to be used as a basis of evaluation of this orthodontic-related bone growth. (Gu et al., Mandibular Growth Changes and Cervical Vertebral Maturation, Angle Orthodontic, Vol. 77, No 6, 947-953 (2007), which is incorporated herein in its entirety by reference.)

The functional appliance 200 includes an appliance body 202, active screws 204, alignment members 206, active screw bosses 208, a labial bow 210, Delta clasps 212, and arrowhead clasps 214. The appliance body 202, which is preferably made from a polymeric material such as acrylic plastic, includes an anterior palatal-engaging portion 202A and posterior occlusal pad portions 202B. Each group of the active screws 204, the alignment members 206 and the active screw bosses 208 jointly define an appliance load assembly. Each of the appliance load assemblies is coupled between the anterior palatal-engaging portion 202A and a respective one of the posterior occlusal pad portions 202B. Load generated by each appliance load assembly is exerted on the respective one of the posterior orthodontic bands 212 and the anterior palatal-engaging portion 202A, thereby providing force required for causing remodeling of the patient's bone structure and/or teeth placement.

In preferred embodiments, as shown, the anterior palatal-engaging portion 202A and the posterior occlusal pad portions 202B can be coupled to each other through the appliance load assembly. Each of the active screw bosses 208 is fixedly mounted on either the anterior palatal engaging portion 202A or a respective one of the posterior occlusal pad portions 202B. The alignment members 206 extend through opposing ones of the active screw bosses 208 for maintaining alignment between the corresponding one of the posterior occlusal pad portions 202B and the anterior palatal-engaging portion 202A.

The functional appliance 200 is secured in place on a patient's teeth (i.e., mounted-on teeth) via the Delta clasps 212 and the arrowhead clasps 214 that are integral with the posterior occlusal pad portions 202B. For example, the Delta clasps 212 and the arrowhead clasps 214 can be cast-into or molded-into the respective one of the posterior occlusal pad portions 202B. A tooth-side surface 216 of each of the posterior occlusal pad portions 202B is formed to receive corresponding teeth (e.g., molars) of the patient. To this end, the tooth-side 216 of each of the posterior occlusal pad portions 202B preferably has a contour defined by an impression of corresponding teeth of the patient received within the tooth-side cavity of the respective one of the posterior occlusal pad portions 202B. A bite-side surface 218 of each of the posterior occlusal pad portions 202B is preferably flat and smooth and extends generally parallel to the opposing teeth (i.e., biting teeth). As best shown in FIGS. 14 and 15, a palate-engaging surface 220 of the anterior palatal-engaging portion 202A has a contour defined by an impression of the palette of the patient.

Rotation of each of the active screws 204 result in a relative distance between the anterior palatal engaging portion 202A and a respective one of the posterior occlusal pad portions 202B being altered. When the functional appliance 200 is installed, such alteration of the distance between the anterior palatal engaging portion 202A and a respective one of the posterior occlusal pad portions 202B provides a corresponding change in force applied by the palatal-engaging portion 202A on the palette of the patient. In this respect, such adjustment provides for selective manipulation of the load exerted on the underlying bony jawbone structure of the patient. In accordance with the aforementioned Wolff's Law, the exertion of the force applied by the palatal-engaging portion 202A on the palette of the patient results in controlled, altered growth of the underlying bony jawbone structure of the patient, which is the underlying objective of the remodeling functionality of the functional appliance 200.

The remodeling functionality of the functional appliance 200 is based on the functionality of conventional MX sagittal appliances. Advantageously, however, the functional appliance 200 includes a plurality of beneficial structural elements for achieving such remodeling functionality that are not provided for by conventional MX sagittal appliances. A first one of these beneficial structural elements is that the active screws 204 preferably have their longitudinal axis positioned to extend parallel to the line of occlusion (i.e., the top of the corresponding teeth of the respective one of the posterior occlusal pad portions 202B), as best shown in FIGS. 13-16. Such parallel orientation mitigates binding of the screw(s) and appliance body portions 202A, 202B during screw adjustment, thereby enhancing load delivery of the active screws between appliance body portions 202A, 202B. A second one of these beneficial structural elements is that the force delivered by active screws 204 deliver preferably about 488 grams for load to the palatal-engaging portion 202A on the palette in response to a one-quarter turn of each of the active screws 104. Such load profile is the result of a non-standard pitch of the active crews 204 (i.e., about a 488-gram load generation at the pallet for one-quarter turn of each active screw 204). A third one of these beneficial structural elements is that the anterior palatal-engaging portion 202A of the appliance body 202 does not touch the MX incisors, thereby optimizing load-delivery to the palette. A fourth one of these beneficial structural elements is that the labial bow is a double loop style, thereby enabling its adjustment, if/when needed. A fifth one of these beneficial structural elements is that the posterior occlusal pad portions 202B are preferably 4 mm thick uniformly measured from the depth of the MX 1^{st} molar fossa to the bite-side surface 218. Beneficially, this thickness results in the posterior occlusal pad portions 202B violating the approximately 1.5-3.25 mm freeway space between the opposing teeth of the jaw, which causes the mandible to remodel (i.e., change shape) to accommodate freeway space being violated and results in the mandible (i.e., lower jaw) being moved to be fit to the maxillary (i.e., the upper jaw on which the functional appliance 200 is mounted). Accordingly, construction of the functional appliance 200 requires MX/MN impressions and a fully intercuspated bite. A sixth one of these beneficial structural elements is that the bite-side surface 218 of each of the posterior occlusal pad portions 202B is flat with no indexes or indentations, whereby as the mandible changes shape, mandible molars can more freely move along bite-side surface 218 of the respective one of the posterior occlusal pad portions 202B to a preferred, natural position where the upper and lower cuspids will fit (i.e., functionality providing self-locate of the lower jaw relative to the upper jaw). A seventh one of these beneficial structural elements is that the posterior one-third of the incisal papilla region of the palatal-engaging portion 202A is configured with a feature to interact with the patient's tongue to mitigate (e.g., reduce or eliminate) tongue thrust, which is known to adversely affect placement of the teeth. To this end, in one or more embodiments, the palatal-engaging portion 202A can have a tongue sensory feature 222 (e.g., a hemispherical divot about 3 mm in diameter) integral therewith. An eighth one of these beneficial structural elements is that the Delta clasps 212 are placed on the 1^{st} molars and the arrowhead clasps 214 are placed between the 1^{st} and 2^{nd} deciduous molars for retention, where such claps 212, 214 are chosen to minimize irritation of the patient's gingiva (i.e., gums).

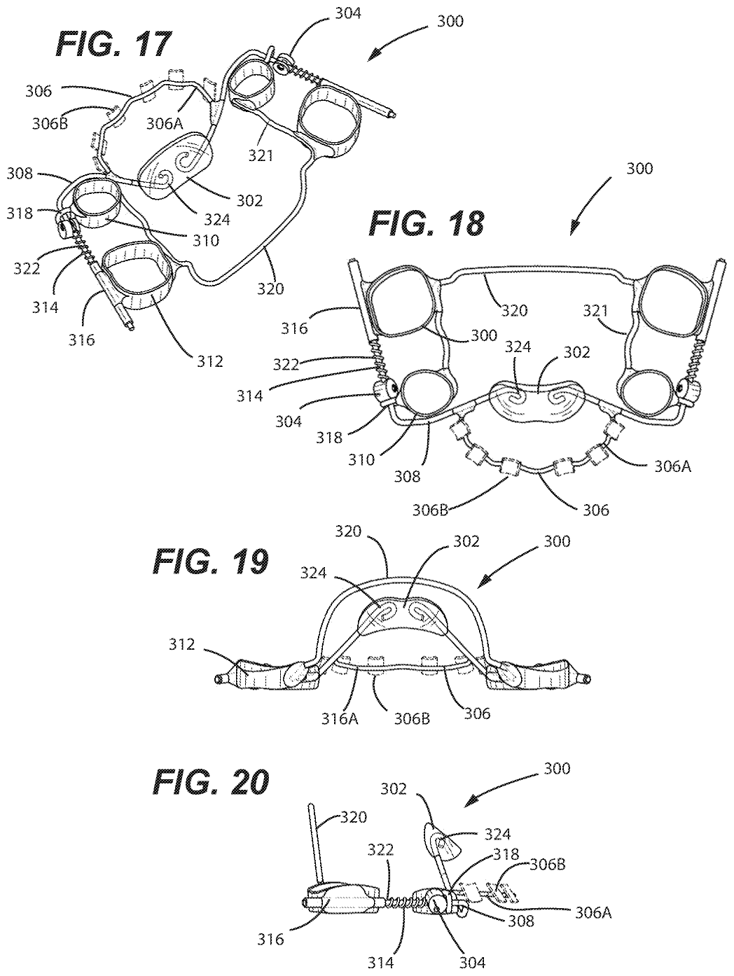

Referring now to FIGS. 17-20, a second embodiment of a functional appliance in accordance with an embodiment of the present invention (i.e., the functional appliance 300) is shown. The functional appliance 300 is used during a patient's orthodontic-related bone growth, thereby taking advantage of the displacement and remodeling occurring in the facial region. Advantageously, in association with the “BIG 3”, the functional appliance 300 effectively and efficiently eliminates excessive cants, eliminates excessive gingival show, and remodels the naso-maxillary complex to a more functional configuration. Moreover, the functional appliance 300 stimulates the MN ramus to upright through remodeling.

Because the functional appliance 300 is preferably used during bone growth stages, it takes advantage of the displacement and remodeling occurring in the facial region (e.g., remodeling occurring in the facial region by influencing residual growth sites). For example, the functional appliance 300 is a fixed functional appliance adapted for use preferably on non-compliant patients during bone growth at cervical vertebral maturation stages 3-4 (e.g., patients about 6 years old to about 10 years old with 1^{st} adult molars and 1^{st} and 2^{nd} deciduous molars) as well as patients over the age of about 9 through adulthood to provide 3-dimensional development of the nasal maxillary (MX) complex (also referred to as the naso-maxillary complex) and upright the mandibular (MN) ramus through remodeling. Such nasal maxillary (MX) complex (also referred to as the naso-maxillary complex) and upright the mandibular (MN) ramus are jointly referred to herein as orthodontic-related bone growth. Cervical vertebral maturation stages are known to be used as a basis of evaluation of this orthodontic-related bone growth. (Gu et al., Mandibular Growth Changes and Cervical Vertebral Maturation, Angle Orthodontic, Vol. 77, No 6, 947-953 (2007), which is incorporated herein in its entirety by reference.)

The functional appliance 300 includes a palatal pad 302, stoplocks 304, a lingual connecting structure 306, active pressure wires 308, anterior orthodontic bands 310, posterior orthodontic bands 312, activation springs 314, molar band tubes 316, pressure wire eyelets 318, a trans-palatal seating wire 320 and molar band wire coupling wires 321. In a preferred embodiment, as shown, each of the anterior orthodontic bands 310 is mounted on the MX 1^{st} bicuspids and each of the posterior orthodontic bands 312 is mounted on the MX 1^{st} molars. Each of the molar band wire coupling wires 321 join a respective each of the anterior orthodontic bands 310 with an adjacent one of the posterior orthodontic bands 312. Each anterior orthodontic bands 310 has one of the pressure wire eyelets 318 mounted thereon and each of the posterior orthodontic bands 312 has one of the molar band tubes 316 mounted thereon. In a preferred embodiment, the lingual connecting structure 306 comprises an anterior lingual stabilization and retention wire 306A and a plurality of cingulum pads 306B each attached to the anterior lingual stabilization and retention wire 306A and configured for being engaged with (e.g., bonded to) the cingulum of a respective incisor or cuspid.

Each one of the active pressure wires 308 has a force-receiving portion 322 and a force-delivering portion 324. The force-receiving portion 322 of each of the pressure wires 308 extends through the pressure wire eyelets 318 of one of the anterior orthodontic bands 310 and into the molar band tubes 316 of an adjacent one of the posterior orthodontic bands 312. Each of the stoplocks 304 is mounted on the force-receiving portion 322 of a respective one of the active pressure wires 308 between the associated one of the pressure wire eyelets 318 and the molar band tubes 316. Each of the stoplocks 304 is slidable along a length to the force-receiving portion 322 of the respective one of the active pressure wires 308 and is selectively securable in a given position thereon. Each of the activation springs 314 is located between the stoplock 304 and molar band tubes 316 associated with a respective one of the active pressure wires 308. In preferred embodiments, each of the activation springs 314 is a helical-wound spring made from a nickel-titanium material and the force-receiving portion 322 of the respective one of the active pressure wires 308 extends axially therethrough. The palatal pad 302, which preferably can be made from polymeric material such as acrylic plastic, has the force-delivering portion 324 of each of the active pressure wires 308 engaged therewith (e.g., molded or cast therein). In this respect, the stoplocks 304, associated ones of the active pressure wires 308, the activation springs 314 and the molar band tubes 316 jointly define an appliance load assembly. Each appliance load assembly is coupled between a respective one of the posterior orthodontic bands 312 and the palatal pad 302. Load generated by each appliance load assembly is exerted on the respective one of the posterior orthodontic bands 312 and the palatal pad 302, thereby providing force required for causing remodeling of the patient's bone structure and/or teeth placement.

Preferably, the functional appliance 300 is constructed in accordance with a patient's MX/MN impressions and a fully intercuspated bite. In use, the functional appliance 300 is installed on a patient by bonding each of the anterior orthodontic bands 310 onto a respective one of the MX 1^{st} bicuspids and bonding each of the posterior orthodontic bands 312 onto a respective one of the MX 1^{st} molars. The portions of the trans-palatal seating wire 320 extending between the anterior orthodontic bands 310 and/or the portions of the trans-molar band wire extending between the posterior orthodontic bands 312 can be removed after such bonding.

To generate active force that is applied onto the palette by the palatal pad 302, each of the stoplocks 304 is slid posteriorly to compress the corresponding one of the activation springs 314 between the stoplock 304 and the molar band tubes 316 and each stoplock 304 is then secured in place (e.g., tightened). Such compression of the activation springs 314 results in forced-forward urging of the active pressure wires 308. This compression causes active force to be applied onto the palette by the palatal pad 302. As the upper jaw is remodeled, the stoplocks 304 can be readjusted to maintain force of the palette by the palatal pad 302.

The remodeling functionality of the functional appliance 300 is based on the functionality of conventional MX sagittal appliances. Advantageously, however, the functional appliance 300 includes a plurality of beneficial structural elements for achieving such remodeling functionality that are not provided for by conventional MX sagittal appliances. A first one of these beneficial structural elements is characterized by a force generating assembly that comprises the palatal pad 302, the stoplocks 304, the anterior and posterior orthodontic bands 310, 312, the active pressure wires 308, the molar band tubes 316, the activation springs 314 and the pressure wire eyelets 318. The force-receiving portion 322 of each of the active pressure wires 308 is generally straight, thereby allowing each of the force-receiving portion 322 to freely extend through the respective one of the molar band tubes 316, the activation springs 314 and the pressure wire eyelets 318. Uniquely, the pressure wire eyelets 318 are facially attached (e.g., welded) to the respective one of the anterior molar bands 310 thereby limiting unrestricted off-axis (i.e., radial) movement of the respective one of the active pressure wires 316. The outside diameter of the active pressure wires 308, the inside diameter of the molar band tubes 316 and inside diameter of the pressure wire eyelets 318 are jointly configured for allowing non-binding movement of the active pressure wires 308 relative to the molar band tubes 316 and the pressure wire eyelets 318 (e.g., at least about 0.002 clearance therebetween. A second one of these beneficial structural elements is that the stoplocks 304 are of a proprietary construction, as shown and discussed herein. A third one of these beneficial structural elements is that the palatal pad 302 is specifically sized and placed to initiate a 3-dimensional (3D) remodeling response to the naso-maxillary complex whereby the depth and width of palatal pad 302 are determined by a patient-specific orthodontic impression. A fourth one of these beneficial structural elements is that the cingulum pads 306B are configured for being bonded to the cingulum of the respective one of the incisors or cuspids to limit unrestricted movement of the palatal pad 302 relative to the palette without the cingulum pads 306B exerting any appreciable load on the teeth with which they are engaged. Optionally, the palatal pad 302 can be omitted and the anterior lingual stabilization and retention wire 306A bonded directly to the cingulum of the respective one of the incisors or cuspids.

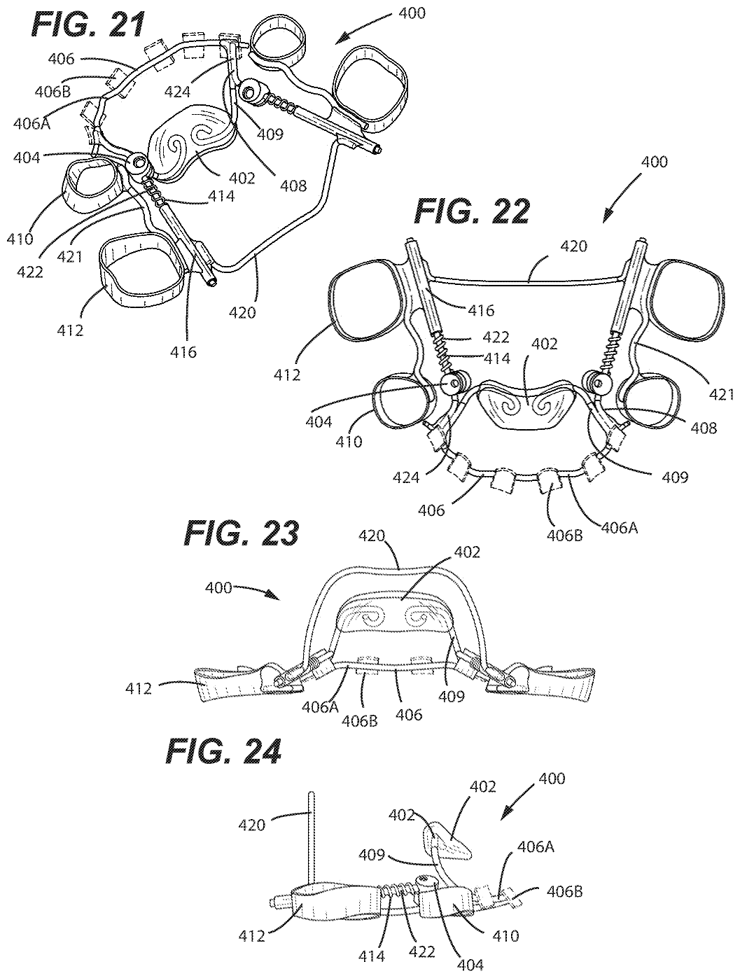

Referring now to FIGS. 21-24, a fourth embodiment of a functional appliance in accordance with an embodiment of the present invention (i.e., the functional appliance 400) is shown. Whereas the functional appliance 400 is a facial anterior growth guidance appliance, the functional appliance 400 is a lingual anterior growth guidance appliance. These lingual and facial appliances provide the same underlying functionalities. However, the lingual anterior growth guidance appliance offers the aesthetic advantage being less visually apparent.

The functional appliance 400 is used during a patient's orthodontic-related bone growth, thereby taking advantage of the displacement and remodeling occurring in the facial region. Advantageously, in association with the “BIG 3”, the functional appliance 400 effectively and efficiently eliminates excessive cants, eliminates excessive gingival show, and remodels the naso-maxillary complex to a more functional configuration. Moreover, the functional appliance 400 stimulates the MN ramus to upright through remodeling.

Because the functional appliance 400 is preferably used during bone growth stages, it takes advantage of the displacement and remodeling occurring in the facial region (e.g., remodeling occurring in the facial region by influencing residual growth sites). For example, the functional appliance 400 is a fixed functional appliance adapted for use preferably on non-compliant patients during bone growth at cervical vertebral maturation stages 3-4 (e.g., patients about 6 years old to about 10 years old with 1^{st} adult molars and 1^{st} and 2^{nd d} deciduous molars) as well as patients over the age of about 9 through adulthood to provide 3-dimensional development of the nasal maxillary (MX) complex (also referred to as the naso-maxillary complex) and upright the mandibular (MN) ramus through remodeling. Such nasal maxillary (MX) complex (also referred to as the naso-maxillary complex) and upright the mandibular (MN) ramus are jointly referred to herein as orthodontic-related bone growth. Cervical vertebral maturation stages are known to be used as a basis of evaluation of this orthodontic-related bone growth. (Gu et al., Mandibular Growth Changes and Cervical Vertebral Maturation, Angle Orthodontic, Vol. 77, No 6, 947-953 (2007), which is incorporated herein in its entirety by reference.)

The functional appliance 400 includes a palatal pad 402, stoplocks 404, a lingual connecting structure 406, active pressure wires 408, force transfer wires 409, anterior orthodontic bands 410, posterior orthodontic bands 412, activation springs 414, molar band tubes 416, a trans-palatal seating wire 420 and molar band wire coupling wires 421. In a preferred embodiment, as shown, each of the anterior orthodontic bands 410 is mounted on the MX 1^{st} bicuspids and each of the posterior orthodontic bands 412 is mounted on the MX 1^{st} molars. Each of the molar band wire coupling wires 421 join a respective each of the anterior orthodontic bands 410 with an adjacent one of the posterior orthodontic bands 412. Each of the posterior orthodontic bands 412 has one of the molar band tubes 416 mounted thereon. In a preferred embodiment, the lingual connecting structure 406 comprises an anterior lingual stabilization and retention wire 406A and a plurality of cingulum pads 406B each attached to the anterior lingual stabilization and retention wire 406A and configured for being engaged with (e.g., bonded to) the cingulum of a respective incisor or cuspid.

Each of the active pressure wires 408 has a force-receiving portion 422 and a force-delivering portion 424. The force-receiving portion 422 of each of the pressure wires 408 extends into the molar band tubes 416 of an adjacent one of the posterior orthodontic bands 412. The force-delivering portion 424 of each of the pressure wires 408 is attached (e.g., welded) to a first end portion of an adjacent one of the force transfer wires 409 and a second end portion of each of the force transfer wires 409 is attached to (e.g., embedded within) the palatal pad 402. The force-delivering portion 424 of each of the pressure wires 408 and/or the first end portion of each of the force transfer wires 409 can be attached (e.g., welded) to an adjacent portion of the anterior lingual stabilization and retention wire 406A. Each of the stoplocks 404 is mounted on the force-receiving portion 422 of a respective one of the active pressure wires 408 between the associated one of the molar band tubes 416 and the adjacent portion of the anterior lingual stabilization and retention wire 406A. Each of the stoplocks 404 is slidable along a length to the force-receiving portion 422 of the respective one of the active pressure wires 408 and is selectively securable in a given position thereon. Each of the activation springs 414 is located between the stoplock 404 and molar band tubes 416 associated with a respective one of the active pressure wires 408. In preferred embodiments, each of the activation springs 414 is a helical-wound spring made from a nickel-titanium material and the force-receiving portion 422 of the respective one of the active pressure wires 408 extends axially therethrough. The palatal pad 402, which preferably can be made from polymeric material such as acrylic plastic, has the force-delivering portion 424 of each of the active pressure wires 408 engaged therewith (e.g., molded or cast therein). In this respect, associated ones of the stoplocks 404, the active pressure wires 408, the activation springs 414 and the molar band tubes 416 jointly define an appliance load assembly. Each of the appliance load assemblies is coupled between a respective one of the posterior orthodontic bands 412 and the palatal pad 402. Load generated by each appliance load assembly is exerted on respective one of the posterior orthodontic bands 412 and the palatal pad 402, thereby providing force required for causing remodeling of the patient's bone structure and/or teeth placement.

Preferably, the functional appliance 400 is constructed in accordance with a patient's MX/MN impressions and a fully intercuspated bite. In use, the functional appliance 400 is installed on a patient by bonding each of the anterior orthodontic bands 410 onto a respective one of the MX 1^{st} bicuspids and bonding each of the posterior orthodontic bands 412 onto a respective one of the MX 1^{st} molars. The portions of the trans-palatal seating wire 420 extending between the anterior orthodontic bands 410 and/or the portions of the trans-molar band wires extending between the posterior orthodontic bands 412 can be removed after such bonding.

To generate active force that is applied onto the palette by the palatal pad 402, each of the stoplocks 404 is slid posteriorly to compress the corresponding one of the activation springs 414 between the stoplock 404 and the molar band tubes 416 and each stoplock 404 is then secured in place (e.g., tightened). Such compression of the activation springs 414 results in forced-forward urging of the active pressure wires 408. This compression causes active force to be applied onto the palette by the palatal pad 402. As the upper jaw is remodeled, the stoplocks 404 can be readjusted to maintain force of the palette by the palatal pad 402.

The remodeling functionality of the functional appliance 400 is based on the functionality of conventional MX sagittal appliances. Advantageously, however, the functional appliance 400 includes a plurality of beneficial structural elements for achieving such remodeling functionality that are not provided for by conventional MX sagittal appliances. A first one of these beneficial structural elements is characterized by a force generating assembly that comprises the palatal pad 402, the stoplocks 404, the anterior and posterior orthodontic bands 410, 412, the active pressure wires 408, the molar band tubes 416 and the activation springs 414. The force-receiving portion 422 of each of the active pressure wires 408 is generally straight, thereby allowing each of the force-receiving portion 422 to freely extend through the respective one of the molar band tubes 416 and the activation springs 414. The outside diameter of the active pressure wires 408 and the inside diameter of the molar band tubes 416 are jointly configured for allowing non-binding movement of the active pressure wires 408 relative to the molar band tubes 316 (e.g., at least about 0.002 clearance therebetween. A second one of these beneficial structural elements is that the stoplocks 404 are of a proprietary construction, as shown and discussed herein. A third one of these beneficial structural elements is that the palatal pad 402 is specifically sized and placed to initiate a 3-dimensional (3D) remodeling response to the naso-maxillary complex whereby the depth and width of palatal pad 302 are determined by a patient-specific orthodontic impression. A fourth one of these beneficial structural elements is that the cingulum pads 406B are configured for being bonded to the cingulum of the respective one of the incisors or cuspids to limit unrestricted movement of the palatal pad 402 relative to the palette without the cingulum pads 406B exerting any appreciable load on the teeth with which they are engaged. Optionally, the palatal pad 402 can be omitted and the anterior lingual stabilization and retention wire 406A bonded directly to the cingulum of the respective one of the incisors or cuspids.

Presented now are examples of use-case methodologies in accordance with fixed appliances of one or more embodiments of the present invention.

### General Use-Case Implementation Examples for System Components

### EXAMPLE 1—MOLAR EXPANSION

For maxillary (MX) molar expansion or mandibular (MN) molar up-righting, use the FRLA (Fixed Removable Lingual Arch) in accordance with system component implementation disclosed in reference to FIGS. 2 and 3. The FRLA is typically installed in the MX and/or MN arches about one month after completion of treatment with one or more functional appliances.

### EXAMPLE 2—EXPANDING CUSPIDS

For cuspid expansion, use FRLA and Lock Stops in accordance with system component implementation disclosed in reference to FIGS. 1-10.

### EXAMPLE 3—MOLAR AND CUSPID EXPANSION

For joint molar and cuspid expansion, use FRLA and Lock Stops in accordance with system component implementation disclosed in reference to FIGS. 1-10.

### EXAMPLE 4—MX SAGITTAL EXPANSION

For anterior expansion or advancement, use a MX Fixed Anterior Growth Guidance Appliance, if sagittal correction is over about 4 mm. Otherwise, use FRLA and thermally-sensitive anterior arch wire with stoplocks and molar band tubes, if advancement is not greater than about 4 mm. Preferably, the anterior arch wire is advanced up to about 1 mm per side until the advancement goal is met.

### EXAMPLE 5—MANDIBULAR ADVANCEMENT

If the required (e.g., mandibular advancement is about 4 mm or less), use occlusal pads in accordance with system component implementation disclosed in reference to FIGS. 1-10, whereby acceptable lip seal, nasal breathing, and elimination of tongue habits is provided.

### Implementation Examples for Treatment-Specific Mechanics Using System Components

### EXAMPLE 6—INITIAL MECHANICS

After bracketing teeth and placing occlusal pads on first and second MN molars, begin with 0.020×0.020 Bio Efficient 4th Generation Multi Modular Thermally Activated NiTi anterior arch wire (such as that commercially available from, for example, Essential Orthodontic Products) with installation of stoplocks. FRLAs should be in place on both arches to ideally position molars transversely while creating profound anchorage. Place stoplocks on anterior arch wire(s). Insert opposing end portions of the anterior arch wire(s) into the anterior ach wire passages of respective one of the molar band tubes. Double check midline marks and position of the stoplocks. Tie anterior arch wire(s) using an elastomeric tie into the bracket slot of the most anterior tooth. Arrange the anterior arch wire(s) so that each anterior arch wire is passive (i.e., not engaged or forced into brackets) and has the shape of a typical broad form dental arch. Adjust each of the stoplocks so that it touches the forward edge (i.e., mesial) of the respective one of the molar band tubes and tighten the stoplock.

Next, engage and tie the anterior arch wire(s) into the bracket slots of a respective arch beginning anteriorly and finishing posteriorly. For example, place the elastomeric ties as follows: central, central, lateral, lateral, cuspid, cuspid, first bicuspid, first bicuspid, second bicuspid and second bicuspid. That is to say, each anterior arch wire will be tied into the bracket slots starting anteriorly and proceeding posteriorly moving from one side to the other.

### EXAMPLE 7—MAINTENANCE MECHANICS

During about the 2nd month of mechanics initiation, correct MX/MN bracket discrepancies by re-bracketing. For MX/MN arch w/crowding, the 0.020×0.020 Bio Efficient 4th Generation Multi Modular Thermally Activated NiTi with stoplocks may unravel and align the teeth in about 2-4 months. Ideally slight spacing should develop (½ mm or less). To assist with severe crowding for the first about 2 months, loosen the stoplocks and advance the anterior arch wire forward by about 1 mm on each side and then re-tightening the stoplocks, thereby re-establishing or increasing force within the anterior arch wire. For MX/MN arch w/spacing, leave 0.020×0.020 Bio Efficient 4th Generation Multi Modular Thermally Activated NiTi for about 2-6 months with stoplocks until the cuspids and bicuspids are protracted or retracted to their ideal position.

### EXAMPLE 8—PROTRACTION MECHANICS

Protract first by consolidating the centrals and lateral incisors together using a power chain. Tie the power chain to the mesial wing of the lateral incisor, engage both central incisors, and then tie to the mesial wing of the opposite lateral incisor. Once the incisors are consolidated, check the midline to confirm that it is in the center of the face. If the midline is off, use a dimple (i.e., bend/discontinuity in anterior arch wire for generating lateral force to move adjacent tooth) in the 0.020×0.020 Bio Efficient 4th Generation Multi Modular Thermally Activated NiTi adjacent to the required tooth (i.e., central incisor) for causing force to center the midline in accordance with Midline Correction Mechanics.

### EXAMPLE 9—MIDLINE CORRECTION MECHANICS

Use dental floss to determine where the midline should be located. If extra spacing is needed between the incisors to move the midline, adjust the anterior arch wire about 1 mm on each side by loosening the stoplocks and moving the 0.020×0.020 anterior arch wire forward about 1 mm and then tightening the stoplocks. Creation of the additional space required may take up to about 2 months before initiating the midline correction.

Determine if the desired midline correction has been achieved by measuring the difference in millimeters from where the current midline is located to the position the midline should be located and in what direction the midline should be moved. (e.g., the difference is 2.5 mm and the midline should move to the patient's left.) If further midline correction is required, with the 0.020×0.020 Bio Efficient NiTi anterior arch wire still engaged in the bracket slots, loosen the stoplocks on each side of the arch (i.e., where the midline is being moved) and shift the dimple so that the edge of the dimple in the anterior arch wire, where it meets the flat wire, is exactly the predetermined number of millimeters from the edge of the bracket of the central incisor where the midline is off. For example, using the example that the midline should be moved 2.5 mm to the patient's left, then the edge of the dimple should be 2.5 mm from the edge of the bracket of the right central incisor.

To complete the midline correction (using the above example), place an elastomeric power chain from the mesial wing of the right lateral incisor, engage both central incisors, the left lateral incisor, and then tie to the mesial wing of the left cuspid. Place single ties on the distal wings of the right lateral incisor and the left cuspid to prevent rotations. If self-ligating brackets are used, the elastomeric power chain will engage the complete brackets without distal single ties. Once the midline is corrected, continue to consolidate the cuspids in accordance with Continued Protraction Mechanics.

### EXAMPLE 10—CONTINUED PROTRACTION MECHANICS

Place a power chain from the mesial wing of the left cuspid to the mesial wing of the right (opposite) cuspid. Place single ties on the distal wings to prevent rotation. Continue using the power chain until the spaces are closed. When self-ligating brackets are present, place a power chain from a cuspid to the opposite cuspid until spaces are closed. Single ties are placed on the bicuspids. The power chain is tied to each bracket except the MX bicuspids and molars. When protracting the MX cuspids, the 0.020×0.020 Bio Efficient NiTi anterior arch wire must be made round by polishing off the corners of the anterior arch wire along the path where the cuspid bracket will travel. Anchorage created without rounding the anterior arch wire could delay active protraction of the MX cuspid. The path that the MX cuspids will travel during protraction is the area from the distal of the cuspid bracket to the distal of the lateral bracket on the same side.

Once the cuspids have been consolidated the first and second bicuspids are protracted as follows: Place a power chain from the mesial wing of a 2nd bicuspid to the mesial wing of the opposite 2nd bicuspid. Place single ties on the distal wings to prevent rotation. Remember to tie each cuspid with a single tie and place the power chain incisally to each cuspid bracket. Continue using the power chain until the 1st and 2nd bicuspids are fully protracted. This may take several months. When self-ligating brackets are present, place a power chain from a 2nd bicuspid to the opposite 2nd bicuspid until the 1st and 2nd bicuspids are fully protracted. Remember to place the power chain incisally to each cuspid bracket. The power chain is tied to each bracket except the cuspids (single tie and power chain loop incisal to the bracket) and the molars.

Once the first (1st) and second (2nd) bicuspids are protracted to contact the distal of the cuspids (the 5-5 are abutted without gaps), a 0.021×0.025 superelastic NiTi (nickel titanium) archwire is placed with stoplocks added on each side so that they contact the distal of the second (2nd) bicuspid brackets. This interim wire allows the clinician to tie in (using FIG. 8 or with metal ligatures) any brackets that are not completely (passively) engaged in the 0.021×0.025 superelastic NiTi wire. The clinician should also double check the bracket placement at this time. Each bracket is singly tied (no power chain) and the FRLA is left in place. With this in mind the clinician is preparing the patient for the next step by perfectly aligning the brackets for the protraction of the molars.

To bring the molars forward, change to the anterior arch wire to a 0.021×0.025 SS (stainless steel) anterior arch wire with stoplocks added on each side so that they contact the distal of the second (2nd) bicuspid brackets. Do not round (i.e., thin) the distal of the 0.021×0.025 SS anterior arch wire at this point. Make sure the 0.021×0.025 SS anterior arch wire fully engages the slot of each bracket ensuring final arch leveling. Place single ties on each bracket with no power chain. Leave the FRLA in place and adjust it if it is impinging the palatal tissue. After about 30 days, remove the FRLA manually or by cutting off the FRLA at the lingual sheaths. Remove the 0.021×0.025 SS anterior arch wire from the mouth, keeping the stoplock in place on the anterior archwire or making note of the relative location of the stoplocks on the anterior arch wire. Round the ends of the 0.021×0.025 SS anterior arch wire to the equivalent of a 0.014 round wire thickness beginning distal of the 2nd bicuspid stoplocks to the end of the wire that passes through the molar band tubes, thereby allowing the effortless protraction of the 1st molars. The rounded stainless steel anterior arch wire decreases the anchorage exerted by the molars and allows the molars to move forward freely.

Next, place the anterior arch wire back into the mouth engaging each bracket slot, keeping the stoplocks tight against the 2nd bicuspid brackets. Tie in each bracket with a single tie except for the 2nd bicuspid brackets. Tie in each 2nd bicuspid bracket with a single tie on the mesial wing. On each side, using a 2 (or 3) loop power chain tie one loop to the distal wing if the 2nd bicuspid bracket and the other loop to the molar hook on the same side. Change to power chains every 3-4 weeks thereafter until the molars are protracted firmly against the 2nd bicuspid on each side.

### EXAMPLE 11—RETRACTION MECHANICS

With the 0.020×0.020 Bio Efficient NiTi anterior arch wire and the stoplocks in place, attach a power chain from the distal wing of the left 1st bicuspid, engage the 2nd bicuspid and end on the molar hook on the same side. Then, attach a power chain from the distal wing of the right 1st bicuspid, engage the 2nd bicuspid and end on the molar hook on the same side. Place single ties on the mesial wings of the 1st bicuspids to prevent rotation and single ties on the cuspids and incisors. Continue using the power chain as described until the spaces are closed and the bicuspids are retracted against the molars. Check the occlusal pads on the MN 1st and 2nd molars making sure that there are no lateral interferences and the pads are flat.

When retracting MX cuspids only, the 0.020×0.020 anterior arch wire must be made rounded by polishing off the corners of the anterior arch wire along the path where the cuspid bracket will travel. In the case of cuspid retraction, the wire should be rounded from the mesial of the cuspid bracket to the mesial of the 1st bicuspid bracket on the same side. The anchorage created without rounding the anterior arch wire could delay active retraction of the MX cuspid. When retracting the left cuspid place a power chain from the distal wing of the left cuspid to the molar hook on the same side (i.e., single tie the bicuspids and do not engage the power chain on the bicuspid brackets). When retracting the right cuspid place a power chain from the distal wing of the right cuspid to the molar hook on the same side (i.e., single tie the bicuspids and do not engage the power chain on the bicuspid brackets). Place single ties on the mesial wings of the cuspids to prevent rotation. Continue using the power chain until the spaces are closed and the cuspids are retracted. Place single ties on the incisors. Check the occlusal pads on the MN 1st and 2nd molars making sure that there are no lateral interferences and the pads are flat.

To retract the 4 MX incisors, choose a broad form 0.021×0.025 Stainless Steel anterior arch wire and round corners of anterior arch wire distal to the lateral incisor brackets and extend the rounding of the corners of the wires to the ends of the anterior arch wire on each side. Insert the 0.021×0.025 Stainless Steel anterior arch wire without stoplocks. Place a power chain from the 1st molar hook engaging all of the brackets and ending on the opposite 1st molar hook.

To retract the 4 MN incisors, before placing a MN 0.021×0.025 Stainless Steel anterior arch wire, slightly round corners of the anterior arch wire distal of the MN lateral incisors and extend the rounding of the corners of the wires to the ends of the anterior arch wire on each side. Remove the occlusal pads from the MN 1st molars. Keep the occlusal pads on the MN 2nd molars. Before placing the MN 0.021×0.025 Stainless Steel anterior arch wire, place separators beginning at the distal contact of the MN left and right cuspids and continue placing the separators in the contacts between the MN bicuspids, the MN bicuspid and MN 1st molar, and the MN 1st molar and MN 2nd molar. This will bring the MN 1st molars and bicuspids into solid occlusion. Place the MN 0.021×0.025 Stainless Steel anterior arch wire and place single ties on each bracket. Leave the separators in for about 2 weeks and remove them. Wait about 2 more weeks and repeat the process, thereafter, again removing the separators in about 2 weeks. Normally 2 repetitions of the separators is sufficient.

If the MN 2nd molars are not present, reduce the height of the pads on the MN 1st molars by about 0.5 mm per nominally month, thereby allowing the MX/MN 1st molars to couple properly. Proceed with the separator sequence as described above. The curve of Spee should correct within 3-5 months in this wire. Once the curve of Spee is level then, place a power chain from the MN left 1st molar hook engaging all of the brackets and ending on the opposite MN right 1st molar hook for retracting the 4 MN incisors. The MN FRLA should not be in the way. If it is, the MN FRLA may be removed. Continue using the power chain until the spaces are closed and the incisors are retracted. If the curve of Spee is deep, the leveling process can be accelerated by placing separators in the MN arch as according to the Spee Leveling Mechanics.

### EXAMPLE 12—SPEE LEVELING MECHANICS

Place separators beginning distal of each MN cuspid between each MN tooth as posterior as possible. Leave the separators in for about 2 weeks and then remove them. After about two weeks, repeat this process until the curve of Spee is level. The MN 0.021×0.025 Stainless Steel anterior arch wire with rounded corners should be in place and any mechanics described above may proceed accordingly. When the MN 1st molar and MN bicuspids are in solid occlusion, continue the power chain from the left MN 1st molar hook engaging all of the brackets and ending on the opposite right MN 1st molar hook, thereby completing the retraction of the 4 MN incisors. Continue using the power chain until the spaces are closed and the incisors are retracted.

### EXAMPLE 13—CASE FINISHING MECHANICS

Case finishing mechanics are rather straightforward when using orthodontic systems and associated methods in accordance with embodiments of the present invention. An anterior arch wire of 0.021×0.025 Stainless Steel is placed in the maxillary and mandibular arches, whereby final closure of interproximal spaces is completed. These large anterior arch wires should be left in place, with regular checks to make certain that bracket integrity is maintained for a minimum of about 120 days. This final undisturbed anterior arch wire stabilization prior to debanding is used to minimize the majority of problems of post treatment relapse in crowded cases. The bands and brackets may be removed after this period of time, and the preferred course of retention is then initiated.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. An orthodontic appliance, comprising:
a molar band assembly comprising a molar band and a pressure wire mounting structure attached to the molar band, wherein the molar band is adapted for being mounted on a maxillary molar of a patient;
an active pressure wire having a distal end portion and a proximate end portion attached to the distal end portion, wherein the distal end portion is slidably engaged with the pressure wire mounting structure; and
a stoplock repositionably secured to the active pressure wire at a location between the distal and proximate end portions thereof and wherein the pressure wire mounting structure is forcibly coupled to the stoplock to bias the proximate end portion of the active pressure away from the molar band tube.

2. The orthodontic appliance of claim 1 wherein:
the active pressure wire is made from a thermally reactive material that generates a displacement force as a function of temperature thereof; and
the stoplock is engaged against a forward-facing end of the pressure wire mounting structure for enabling the displacement force generated by the active pressure wire to be applied through the stoplock to the pressure wire mounting structure.

3. The orthodontic appliance of claim 2 wherein the thermally reactive material is nickel titanium wire.

4. The orthodontic appliance of claim 1, further comprising:
an anterior orthodontic band adapted for being mounted on a maxillary bicuspid of the patient; and
a pressure wire eyelet attached to the anterior orthodontic band, wherein the active pressure wire extends through the pressure wire eyelet.

5. The orthodontic appliance of claim 1 wherein:
the pressure wire mounting structure is a molar band tube having a central passage; and
the distal end portion is slidably engaged within the central passage of the molar band tube.

6. The orthodontic appliance of claim 1, further comprising:
a helical-wound activation spring positioned between the pressure wire mounting structure and the stoplock, wherein the distal end portion of the active pressure wire extends through a central passage of the activation spring and wherein the stoplock is repositionably secured to the active pressure wire so as to enable compression of the activation spring between the pressure wire mounting structure and the stoplock whereby the force-delivering portion of the active pressure is biased away from the pressure wire mounting structure.

7. The orthodontic appliance of claim 6 wherein
the pressure wire mounting structure is a molar band tube having a central passage; and
the distal end portion is slidably engaged within the central passage of the molar band tube.

8. The orthodontic appliance of claim 6, further comprising:
an anterior orthodontic band adapted for being mounted on a maxillary bicuspid of the patient; and
a pressure wire eyelet attached to the anterior orthodontic band, wherein the active pressure wire extends through the pressure wire eyelet.

9. The orthodontic appliance of claim 8 wherein:
the pressure wire mounting structure is a molar band tube having a central passage; and
the distal end portion is slidably engaged within the central passage of the molar band tube.

10. An orthodontic appliance, comprising:
opposing molar bands each adapted for being mounted on a respective maxillary molar of a patient;
one or more force delivery structures each adapted for being engaged with at least one of a dental palette of the patient and one or more maxillary incisors thereof; and
opposing appliance load assemblies each including a stoplock, a molar band tube and an active pressure wire, wherein the molar band tube is attached to a respective one of the molar bands, wherein a force-receiving portion of the active pressure wire is slidably engaged with the molar band tube and a force-delivering portion of the active pressure wire is fixedly engaged with at least one of the one or more force delivery structures, wherein the stoplock is repositionably secured to the force-receiving portion of the active pressure wire and wherein the molar band tube is forcibly coupled to the stoplock to bias the force-delivering portion of the active pressure away from the molar band tube.

11. The orthodontic appliance of claim 10 wherein:
the one or more force delivery structures consists of a palatal pad adapted for being engaged with the dental palette of the patient; and
the force-delivering portion of the active pressure wire of each of the opposing appliance load assemblies is fixedly engaged with the palatal pad.

12. The orthodontic appliance of claim 11 wherein the force-delivering portion of the active pressure wire is fixedly engaged directly with the palatal pad.

13. The orthodontic appliance of claim 11 wherein:
each one of the appliance load assemblies includes a force transfer wire;
the force-delivering portion of the active pressure wire is fixedly engaged directly with a first end portion of the force transfer wire; and
the palatal pad is fixedly engaged directly with a second end portion of the force transfer wire.

14. The orthodontic appliance of claim 10 wherein:
the active pressure wire is made from a thermally reactive material that generates a displacement force as a function of temperature thereof;
the thermally reactive material is nickel titanium wire; and
the stoplock is engaged against a forward-facing end of the pressure wire mounting structure for enabling the displacement force generated by the active pressure wire to be applied through the stoplock to the pressure wire mounting structure.

15. The orthodontic appliance of claim 10, further comprising:
opposing anterior orthodontic bands each adapted for being mounted on a respective maxillary bicuspid of the patient; and
pressure wire eyelets each attached to a respective one of the anterior orthodontic bands, wherein the active pressure wire of each of the appliance load assemblies extends through an associated one of the pressure wire eyelets.

16. The orthodontic appliance of claim 10, further comprising:
helical-wound activation springs each positioned between the pressure wire mounting structure and the stoplock of a respective one of the appliance load assemblies, wherein the distal end portion of the active pressure wire extends through a central passage of the activation spring and wherein the stoplock is repositionably secured to the active pressure wire so as to enable compression of the activation spring between the pressure wire mounting structure and the stoplock whereby the force-delivering portion of the active pressure is biased away from the pressure wire mounting structure.

17. The orthodontic appliance of claim 16 wherein
the molar band tube has a central passage; and
the distal end portion is slidably engaged within the central passage of the molar band tube.

18. The orthodontic appliance of claim 16, further comprising:
opposing anterior orthodontic bands each adapted for being mounted on a respective maxillary bicuspid of the patient; and
pressure wire eyelets each attached to a respective one of the anterior orthodontic bands, wherein the active pressure wire of each of the appliance load assemblies extends through an associated one of the pressure wire eyelets.

19. The orthodontic appliance of claim 18 wherein:
the molar band tube has a central passage; and
the distal end portion is slidably engaged within the central passage of the molar band tube.

20. An orthodontic appliance, comprising:
opposing posterior orthodontic bands each adapted for being mounted on a respective maxillary first molar of a patient;
opposing anterior orthodontic bands each adapted for being mounted on a respective maxillary first bicuspid of the patient, wherein each of the anterior orthodontic bands is fixedly attached to a respective adjacent one of the posterior orthodontic bands;
a palatal pad adapted for being engaged with a dental palette of the patient; and
opposing appliance load assemblies each including a stoplock, a molar band tube, an active pressure wire and an activation spring, wherein the molar band tube is attached to a respective one of the posterior molar bands, wherein a force-receiving portion of the active pressure wire is slidably engaged within a central passage of the molar band tube and a force-delivering portion of the active pressure wire is fixedly engaged with the palatal pad, wherein the activation spring is positioned between the molar band tube and the stoplock, and wherein the stoplock is repositionably secured to the force-receiving portion of the active pressure wire so as to enable compression of the activation spring between the molar band tube and the stoplock whereby the force-delivering portion of the active pressure is biased away from the molar band tube.

21. The orthodontic appliance of claim 20 wherein the force-delivering portion of the active pressure wire is fixedly engaged directly with the palatal pad.

22. The orthodontic appliance of claim 20 wherein:
each one of the appliance load assemblies includes a force transfer wire;
the force-delivering portion of the active pressure wire is fixedly engaged directly with a first end portion of the force transfer wire; and
the palatal pad is fixedly engaged directly with a second end portion of the force transfer wire.

23. The orthodontic appliance of claim 20, further comprising:
pressure wire eyelets each attached to a respective one of the anterior orthodontic bands, wherein the active pressure wire of each of the appliance load assemblies extends through an associated one of the pressure wire eyelets.

24. The orthodontic appliance of claim 20 wherein:
the activation spring is a helical-wound activation spring positioned between the pressure wire mounting structure and the stoplock; and
the force-receiving portion of the active pressure wire extends through a central passage of the activation spring.

25. The orthodontic appliance of claim 24 wherein
the molar band tube has a central passage; and
the distal end portion is slidably engaged within the central passage of the molar band tube.

26. The orthodontic appliance of claim 24, further comprising:
pressure wire eyelets each attached to a respective one of the anterior orthodontic bands, wherein the active pressure wire of each of the appliance load assemblies extends through an associated one of the pressure wire eyelets.

27. The orthodontic appliance of claim 26 wherein:
the molar band tube has a central passage; and
the distal end portion is slidably engaged within the central passage of the molar band tube.
